(19) United States
(12) Patent Application Publication
(10) Pub. No.: US 2026/0267523 A1
(43) Pub. Date: Sep. 10, 2026

(54) METHOD FOR PREDICTING LIFETIME OF RESISTIVE RANDOM ACCESS MEMORY CHIP

(71) Applicant: INSTITUTE OF MICROELECTRONICS, CHINESE ACADEMY OF SCIENCES, Beijing (CN)

(72) Inventors: Xiaoxin XU, Beijing (CN); Xu ZHENG, Beijing (CN); Lizhou WU, Beijing (CN); Xiaoyong XUE, Beijing (CN); Wan PANG, Beijing (CN)

(21) Appl. No.: 19/165,862

(22) PCT Filed: Nov. 30, 2023
(86) PCT No.: PCT/CN2023/135508

§ 371 Date: Sep. 16, 2025

(30) Foreign Application Priority Data
Mar. 16, 2023 (CN) 202310253763.6

(51) Int. Cl. G06F 3/06

(52) U.S. Cl. CPC G06F 3/0616; G06F 3/0653; G06F 3/0673

(57) ABSTRACT

The present disclosure provides a method for predicting a lifetime of a resistive random access memory (RRAM) chip, which relates to the field of chip reliability technology and solves the problem of low prediction accuracy of existing methods for predicting a lifetime of an RRAM chip. The method includes: acquiring measured data of a memory cell in the RRAM chip performing read/write operations in a set/reset cycle under normal operating conditions; processing the measured data to obtain nine-dimensional input data X_{pt[i]}; inputting the input data X_{pt[i]} into a corresponding trained failure prediction model to obtain a binary classification prediction result indicating a true failure or a false failure of the memory cell in a next set/reset cycle t+1; and performing, if the binary classification prediction result indicates a false failure, a secondary determination to obtain a prediction result indicating whether a false failure memory cell actually requires repair.

### CROSS REFERENCE TO RELATED APPLICATION

This application is a Section 371 National Stage Application of International Application No. PCT/CN2023/135508, filed on Nov. 30, 2023, entitled “METHOD FOR PREDICTING LIFETIME OF RESISTIVE RANDOM ACCESS MEMORY CHIP”, which claims priority to Chinese Patent Application No. 202310253763.6 filed on Mar. 16, 2023, the content of which is incorporated herein by reference in its entirety.

### TECHNICAL FIELD

The present disclosure pertains to the field of chip reliability technology, and in particular to a method for predicting a lifetime of a resistive random access memory chip.

### BACKGROUND

Resistive random access memory (RRAM) is an embedded non-volatile memory (NVM) applicable to advanced process nodes. It has advantages such as low power consumption, high reliability, and good compatibility with CMOS processes, and thus has significant application value in Internet of Things (IoT) terminal devices. In the complex failure modes of RRAM chips, two modes, namely “true failure” and “false failure” may occur with the increase in the number of continuous set/reset cycles of memory cells.

At present, research on RRAM lifetime prediction mostly focuses on physical modeling for individual devices. Since such modeling considers only the changes in physical quantities inside memory cells and failure mechanisms, while ignoring inevitable noise and defects in devices within an actual chip due to system-level and fabrication processes, it is necessary to construct a reliability model in a data-driven manner based on statistical data. As a result, physical models based on individual devices have limited reference value for predicting the actual lifetime of a chip. With the continuous development of machine learning (ML), modeling the failure behavior of memory cells based on statistical data using ML has provided a pathway for chip-level failure prediction. At present, there is only one reported study involving chip-level failure prediction, but its prediction accuracy is not high and no corresponding optimization solution is provided. Therefore, there is an urgent need for a method for predicting a lifetime of a resistive random access memory chip to achieve more accurate chip-level failure prediction of resistive random access memory cells, so as to provide a basis for pre-allocating storage space and performing repair operations to reduce an error rate of memory cells in RRAM chips.

### SUMMARY

In an aspect, an embodiment of the present disclosure provides a method for predicting a lifetime of a resistive random access memory (RRAM) chip, including: acquiring measured data of a memory cell in the RRAM chip performing read/write operations in a set/reset cycle under normal operating conditions; processing the measured data to obtain input data X_{pt[i]}, where the input data X_{pt[i]} includes a forming voltage FV_{pt[i]}, a normalized resistance of set SR_{pt[i]}, a normalized resistance of reset RR_{pt[i]}, a local fluctuation of resistance of set SF_{pt[i]}, a local fluctuation of resistance of reset RF_{pt[i]}, a global fluctuation of resistance of set SVAR_{pt[i]}, a global fluctuation of resistance of reset RVAR_{pt[i]}, an average set voltage SVOL_{pt[i]}, and an average reset voltage RVOL_{pt[i]}; inputting the input data X_{pt[i]} into a corresponding trained failure prediction model to obtain a binary classification prediction result indicating a true failure or a false failure of the memory cell in a next set/reset cycle t+1; and performing, if the binary classification prediction result indicates a false failure, a secondary determination to obtain a prediction result indicating whether a false failure memory cell actually requires repair.

Furthermore, the acquiring measured data includes: step (1) of acquiring a forming voltage FVₚ for performing a forming operation on a brand-new RRAM chip; and step (2) of recording measured data of each memory cell in the formed RRAM chip in each set/reset cycle under normal operating conditions, where a set/reset cycle includes: the memory cell completing a span of operations in the set/reset cycle, and then sequentially completing a first read operation consecutively and repeatedly for a predetermined number n of times, a set operation for one time, and a second read operation consecutively and repeatedly for a predetermined number n of times; a span of operations in the set/reset cycle includes the memory cell completing set/reset operations for a predetermined number N of times; the measured data Dₚₜ includes: a set voltage SVOL_RAW_{p[i]}, a reset voltage RVOL_RAW_{p[i]}, a resistance of set SR_RAW_{p[i]} and a resistance of reset RR_RAW_{p[i]} recorded within a span in the set/reset cycle, a resistance of reset sample R_{pr[i]} recorded when performing the first read operation consecutively and repeatedly in the set/reset cycle, a resistance of set sample R_{ps[i]} recorded when performing the second read operation consecutively and repeatedly in the set/reset cycle, a resistance of set R_{pset[i]} and a set voltage V_{pset[i]} recorded between the first read operations and the second read operations, and all output results O_{p[i]} in the set/reset cycle.

Furthermore, the processing the measured data to obtain input data X_{pt[i]} includes: (1) setting a value of FV_{pt[i]} in a first set/reset cycle to the forming voltage FVₚ of the chip, and setting values in subsequent set/reset cycles to 0, where FV_{pt[i]} represents the forming voltage of the memory cell; (2) dividing the mean of a raw resistance of set SR_RAW_{pt[i]} by a stable low resistance R_{low} of the RRAM chip to obtain SR_{pt[i]}, where SR_{pt[i]} represents a normalized resistance of set; (3) dividing the mean of a raw resistance of reset RR_RAW_{pt[i]} by a stable high resistance R_{high} of the RRAM chip to obtain RR_{pt[i]}, where RR_{pt[i]} represents a normalized resistance of reset; (4) normalizing the resistance of set samples and convolving the normalized resistance of set samples with a one-dimensional edge detection operator [−1, 0, 1] to obtain SF_{pt[i]}, where SF_{pt[i]} represents a local fluctuation of resistance of set of the memory cell; (5) normalizing the resistance of reset samples and convolving the normalized resistance of reset samples with a one-dimensional edge detection operator [−1, 0, 1] to obtain RF_{pt[i]}, where RF_{pt[i]} represents a local fluctuation of resistance of reset of the memory cell; (6) normalizing each resistance in the resistance of set samples and calculating a variance to obtain SVAR_{pt[i]}, where SVAR_{pt[i]} represents a global fluctuation of resistance of set of the memory cell; (7) normalizing each resistance in the resistance of reset samples and calculating a variance to obtain RVAR_{t[i]}, where RVAR_{t[i]} represents a global fluctuation of resistance of reset of the memory cell; (8) averaging all recorded set voltages within a span in the set/reset cycle to obtain SVOL_{pt[i]}, where SVOL_{pt[i]} represents an average set voltage for the memory cell; and (9) averaging all recorded reset voltages within a span in the set/reset cycle to obtain RVOLₚt[i], where RVOL_{pt[i]} represents an average reset voltage for the memory cell.

Furthermore, the binary classification prediction result indicating a true failure or a false failure is obtained by: inputting the preprocessed data X_{pt[i]} obtained after a set/reset cycle into a trained model M_{trained[i]}, and outputting Y_{pt[i]} as the prediction result for the memory cell in the next set/reset cycle t+1, where if Y_{t[i]}=1, the prediction result indicates a false failure of the memory cell in the next time slice; and if Y_{t[i]}=0, the prediction result indicates a true failure of the memory cell in the next time slice; and a prediction result indicating whether a false failure memory cell actually requires repair is obtained by: performing a secondary determination on the prediction result if Y_{t[i]}=1, and if the output result O_{t[i]} for the memory cell in a current set/reset cycle t indicates N+1 set successes and N reset successes, determining that the prediction result indicates that the memory cell does not require repair; otherwise, determining that the prediction result indicates that the memory cell is a false failure memory cell that actually requires repair.

Furthermore, the trained failure prediction model is obtained by: acquiring raw data Dₜ; preprocessing the raw data to obtain nine-dimensional input data Xₜ={FVₜ, SRₜ, RRₜ, SFₜ, RFₜ, SVARₜ, RVARₜ, SVOLₜ, RVOLₜ}; constructing a dataset D₁ having a data structure of K×9×T according to the nine-dimensional input data, and performing binary classification labeling of true failure or false failure on the dataset D₁ to obtain a model training dataset D₂ consisting of external inputs Xₜ of a model M and corresponding labels Cₜ, where K is a total number of memory cells in the RRAM chip, and T is a number of simulation cycles covered by the raw data; and training the model M using the model training dataset D₂, where the model M includes K long short-term memory (LSTM) replica models {M_{[0]}, M_{[1]}, . . . , M_{[K-1]}} with identical parameters, and different replica models are configured to independently perform forward inference and error computation for the K memory cells.

Furthermore, the model M is constructed based on LSTM, with cell parameters including a cell state Cₜ, a hidden state Hₜ, and a state update value Uₜ, and with control gates including a forget gate FG, an input gate IG, and an output gate OG, respectively expressed as:

$$FG = sigmoid ( {I}_{t} \times WF + BF ) , \\ IG = sigmoid ( {I}_{t} \times WI + BI ) , \\ OG = sigmoid ( {I}_{t} \times WO + BO ) ,$$

where WF, WI and WO represent weights for the forget gate, the input gate, and the output gate respectively in performing an affine transformation on a current neural network input Iₜ in a current time slice; BF, BI and BO represent biases for the forget gate, the input gate, and the output gate respectively in performing the affine transformation.

An iterative computation of the model M includes:
step (1) of splitting input data {D₂}ₜ in each time slice into K nine-dimensional vectors, and inputting the K nine-dimensional vectors respectively into K LSTM replica models with identical parameters;
step (2) of concatenating a current external input X_{t[i]} in a current time slice Tₜ with a hidden state Hₜ₋₁ from a previous time slice Tₜ₋₁ to obtain a current neural network input Iₜ in the current time slice Tₜ;
step (3) of performing an affine transformation on the current neural network input Iₜ and then performing an activation with a tanh function to obtain a current state update value Uₜ;
step (4) of performing an element-wise multiplication between the forget gate FG and the cell state Cₜ₋₁ from the previous time slice Tₜ₋₁ and between the input gate IG and the current state update value Uₜ, and summing two multiplication results to obtain a current cell state Cₜ;
step (5) of performing a tanh activation on the current cell state C₁, and then performing an element-wise multiplication with the output gate OG to obtain a current hidden state Hₜ;
step (6) of inputting the current hidden state Hₜ into the neural network to participate in a loop calculation in the next time slice Tₜ₊₁, repeatedly performing steps (2) to (5) while mapping the current hidden state Hₜ into a two-dimensional space through an affine transformation, performing an activation with a softmax function to obtain a current two-dimensional vector Pₜ, and taking an index value of a larger one of two elements in the current two-dimensional vector Pₜ as a current model output Y_{t[i]};
step (7) of concatenating the two-dimensional vectors Pₜ along a time dimension to form an output array P of size K×TS×2, concatenating the label arrays Cₜ along the time dimension to form an output array C of size K×TS×2, and comparing the output array P and the output array C to obtain a cross entropy as a loss function, expressed as:

$$L = - \frac{1}{K} {\sum }_{t = 1}^{TS} {\sum }_{i = 1}^{K} {[ {c}_{i}^{1} log {p}_{i}^{1} + {c}_{i}^{0} log {p}_{i}^{0} ]}_{t}$$

where TS represents a training span, and a value of TS is equal to the number of time slices covered by the training dataset Dₜᵣₐᵢₙ; K is a total number of memory cells in the RRAM chip, a label for a single memory cell has a data structure of [c⁰, c¹], i represents an i^{th} memory cell, and t represents a t^{th} time slice; and
back-propagating a loss and updating weights of the K LSTM replica models simultaneously until the loss ceases to decrease so that K trained LSTM replica models are obtained, and selecting any one of the replica models as a final model M_{trained}, where M_{trained}={M_{trained_[0]}, M_{trained [1]}, . . . , M_{trained_[K-1]}}, and preferably, an Adam optimizer is provided for back-propagation and weight updates of the neural network.

Furthermore, the acquiring raw data Dₜ includes:
step (1) of performing a forming operation on the RRAM chip to switch each memory cell of the chip into a conductive state, and recording a forming voltage FV;
step (2) of verifying a forming result and recording a forming resistance R_{f} and an output result O for each memory cell;
step (3) of performing a set operation on the formed chip, and recording a resistance SR_RAW and a corresponding set voltage SVOL_RAW for each memory cell upon the set operation being successful, or the resistance SR_RAW and the corresponding set voltage SVOL_RAW for each memory cell upon the set operation failing for a predetermined number of times, along with an output result O, where the set operation being successful includes the set operation being successful when being performed once, or the set operation being successful when being performed multiple times not more than the predetermined number of times;
step (4) of performing a reset operation on the formed chip, and recording a resistance RR_RAW and a corresponding reset voltage RVOL_RAW for each memory cell upon the reset operation being successful, or the resistance RR_RAW cell and the corresponding reset voltage RVOL_RAW for each memory upon the reset operation failing for a predetermined number of times, along with an output result O;
step (5) of repeatedly performing the set operation and the reset operation to complete a predetermined number N of cycles in a span, including: repeatedly performing step (3) to step (4), defining a completion of a span upon completing the predetermined number of cycles, and proceeding to step (6);
step (6) of repeatedly performing a read operation on a memory array of the chip for a predetermined number n of times to obtain resistance of reset samples Rᵣ for computing a resistance of reset fluctuation;
step (7) of performing a set operation on the chip, and recording a resistance Rₛₑₜ and a current set voltage Vₛₑₜ for each memory cell upon the set operation being successful, or the resistance Rₛₑₜ and the current set voltage Vₛₑₜ for each memory cell upon the set operation failing for a predetermined number of times, along with an output result O;
step (8) of repeatedly performing a read operation for the predetermined number n of times to obtain resistance of set samples Rₛ for computing a resistance of set fluctuation; and
step (9) of defining step (3) to step (8) as a simulation cycle, and performing T simulation cycles to obtain the raw data Dₜ={FV, SVOL_RAW, RVOL_RAW, SR_RAW, RR_RAW, Rᵣ, Rₛ, Rₛₑₜ, Vₛₑₜ . . . }ₜ.

Furthermore, the external input Xₜ includes: (1) FVₜ represents a forming voltage, a value of FVₜ in a first time slice is set to the FV in the raw data, and values for subsequent time slices are set to 0; (2) SRₜ represents a normalized resistance of set and is obtained by dividing the mean of a raw resistance of set SR_RAW by a stable low resistance R_{low} of the RRAM chip, R_{low} is a low resistance of a memory cell during a normal operation of the RRAM chip and also a low resistance in the most stable state; (3) RRₜ represents a normalized rest resistance and is obtained by dividing the mean of a raw resistance of reset RR_RAW by a stable high resistance R_{high} of the RRAM chip, R_{high} is a high resistance of a memory cell during a normal operation of the RRAM chip and also a high resistance in the most stable state; (4) SFₜ represents a local fluctuation of the resistance of set of the memory cell and is obtained by normalizing the resistance of set samples and convolving the normalized resistance of set samples with a one-dimensional edge detection operator [−1, 0, 1]; (5) RFₜ represents a local fluctuation of the resistance of reset of the memory cell and is obtained by normalizing the resistance of reset samples and convolving the normalized resistance of reset samples with the one-dimensional edge detection operator [−1, 0, 1]; (6) SVARₜ represents a global fluctuation of the resistance of set of the memory cell and is obtained by normalizing each resistance in the resistance of set samples and calculating a variance; (7) RVARₜ represents a global fluctuation of the resistance of reset of the memory cell and is obtained by normalizing each resistance in the resistance of reset samples and calculating a variance; (8) SVOLₜ represents an average set voltage of the memory cell and is obtained by averaging all recorded set voltages within a span in the simulation cycle; and (9) RVOLₜ represents an average reset voltage of the memory cell and is obtained by averaging all recorded reset voltages within a span in the simulation cycle.

Furthermore, the performing binary classification labeling of true failure or false failure includes:
step (1) of determining a state result S_{t[i]} of the memory cell in a (t+1)^{th} simulation cycle according to an output result O_{t+1[i]} within each span in the (t+1)^{th} simulation cycle, where:
   a) if O_{t+1[i]} does not contain set success or reset success, the state result S_{t+1[i]}=0, indicating that the memory cell undergoes a true failure in the (t+1)^{th} simulation cycle; or
   b) in other cases except a), the state result S_{t+1[i]}=1, indicating that the memory cell undergoes a false failure in the (t+1)^{th} simulation cycle;
step (2) of assigning a corresponding label

$${c}_{t [ i ]} = {[ {c}_{i}^{0} , {c}_{i}^{1} ]}_{t}$$

to X_{t[i]} according to the state result S_{t+1[i]}, where superscripts 0 and 1 represent indices of a two-dimensional vector, where:
   i. if the state result S_{t+1[i]}=0, a corresponding label c_{t[i]}=[1, 0]ₜ is assigned to X_{t[i]}; and
   ii. if the state result S_{t+1[i]}=1, a corresponding label c_{t[i]}=[0, 1]ₜ is assigned to X_{t[i]}; and
step (3) of constructing T matrices of size K×2 on a per-time-slice basis as labels Cₜ corresponding to external inputs Xₜ of the model M, where Cₜ={C_{[0]}, C_{[1]}, . . . , C_{[K-1]}}ₜ; combining each Xₜ and the corresponding label Cₜ to form model training data D_{2_t}, and constructing T model training data D_{2_t} t on a per-time-slice basis as the model training dataset D₂, where D₂={D_{2_0}, D_{2_1}, . . . , D_{2_T-1}}.

Furthermore, the training a model M using a model training dataset D₂ includes: dividing the model training dataset D₂ by time slices into a training dataset Dₜᵣₐᵢₙ and a test dataset Dₜₑₛₜ, where data of first TS time slices in the model training dataset D₂ is allocated to the training dataset Dₜᵣₐᵢₙ={D_{2_0}, D_{2_1}, . . . , D_{2_TS-1}}, and data of the remaining T-TS time slices is allocated to the test dataset Dₜₑₛₜ={D_{2_TS-1}, D_{2_TS}, . . . , D_{2_T-1}}; initializing the model M to set initial values of a cell state and a hidden state of the LSTM to 0; and constructing the model M as K LSTM replica models {M_{[0]}, M_{[1]}, . . . , M_{[K-1]}} with identical parameters; and splitting input data {D₂}ₜ of each time slice in the training dataset Dₜᵣₐᵢₙ into K nine-dimensional vectors Xₜ={X_{[0]}, X_{[1]}, . . . , X_{[K-1]}}ₜ, sequentially inputting the split data in time-slice order into the K LSTM replica models M={M_{[0]}, M_{[1]}, . . . , M_{[K-1]}} with identical parameters for model training to obtain K trained replica models, selecting any one of the K trained replica models as a final model M_{trained}, and testing the final model M_{trained} using the test dataset Dₜₑₛₜ.

### BRIEF DESCRIPTION OF THE DRAWINGS

The accompanying drawings are provided solely for the purpose of showing specific embodiments and are not considered as limiting the present disclosure. Throughout the accompanying drawing, the same reference signs represent the same components.

FIG. 1 shows a flowchart of a method for predicting a lifetime of a resistive random access memory chip according to an embodiment of the present disclosure;

FIG. 2 shows a schematic diagram of memory cells and array structure of an RRAM chip according to an embodiment of the present disclosure;

FIGS. 3A and 3B show a flowchart of acquiring raw data according to an embodiment of the present disclosure;

FIG. 4 shows an overall schematic diagram of an LSTM architecture according to an embodiment of the present disclosure;

FIG. 5 shows a schematic diagram of model training based on LSTM according to an embodiment of the present disclosure;

FIG. 6 shows a schematic diagram of a prediction method of an RRAM chip lifetime model according to an embodiment of the present disclosure;

FIG. 7 shows a schematic diagram of a repair voltage applied to a false failure memory cell according to an embodiment of the present disclosure;

FIG. 8 shows a schematic diagram of a morphology of conductive filaments in a memory cell during the application of the repair method according to an embodiment of the present disclosure; and

FIG. 9 shows a bar chart of statistical results for prediction accuracy of prediction task models containing different time slices according to an embodiment of the present disclosure.

### DETAILED DESCRIPTION OF EMBODIMENTS

The preferred embodiments of the present disclosure will be described in detail below with reference to the accompanying drawings. The accompanying drawings form a part of the present disclosure and are used to explain the principles of the present disclosure together with the embodiments of the present disclosure, and are not used to limit the scope of the present disclosure.

Embodiments of the present disclosure aim to provide a method for predicting a lifetime of a resistive random access memory chip, so as to solve the problem of low prediction accuracy of existing methods for predicting a lifetime of an RRAM chip.

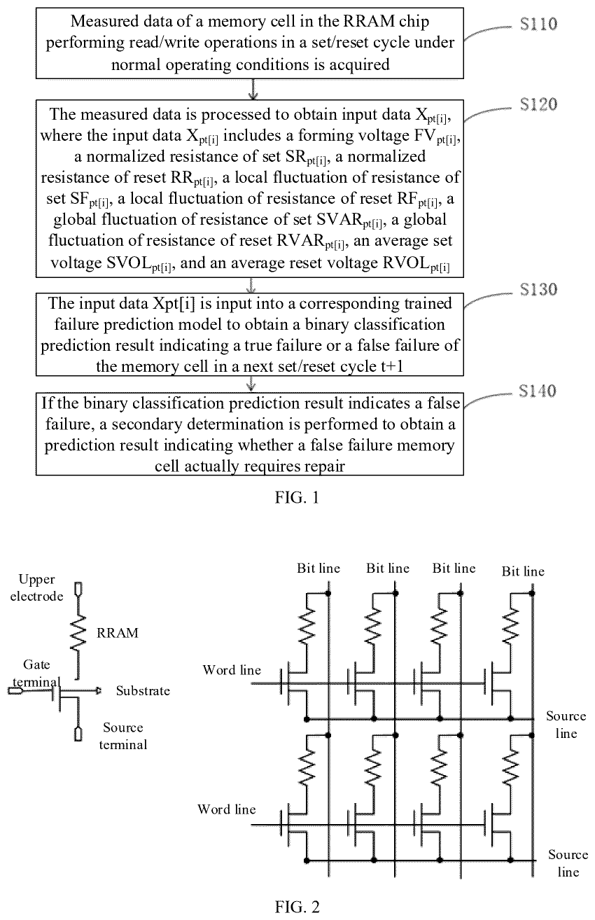

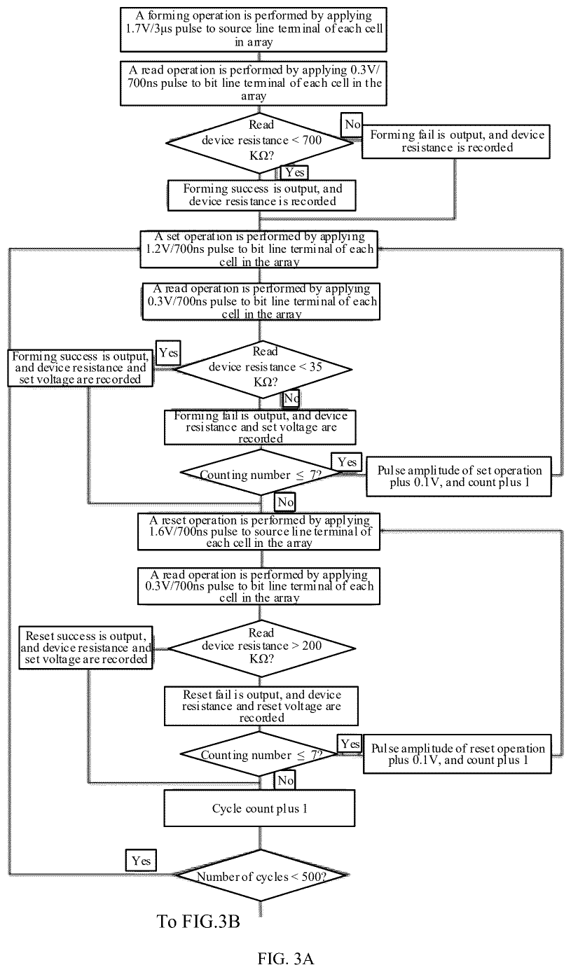

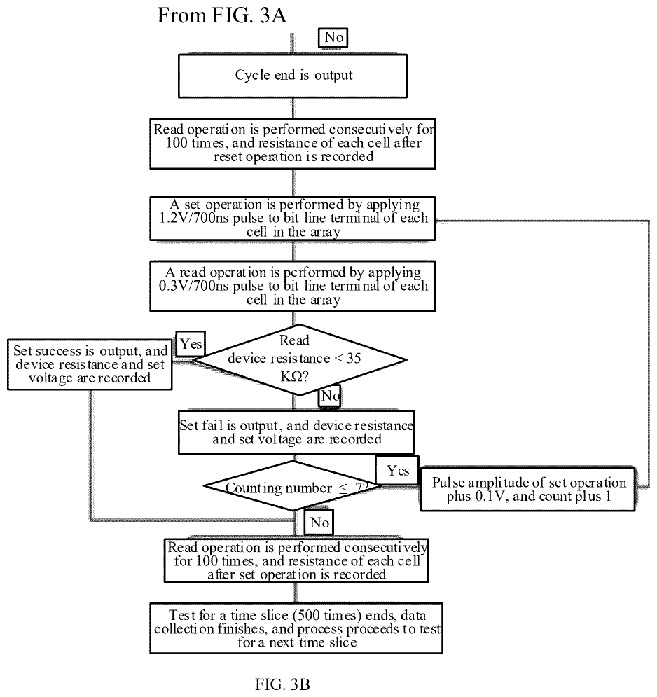

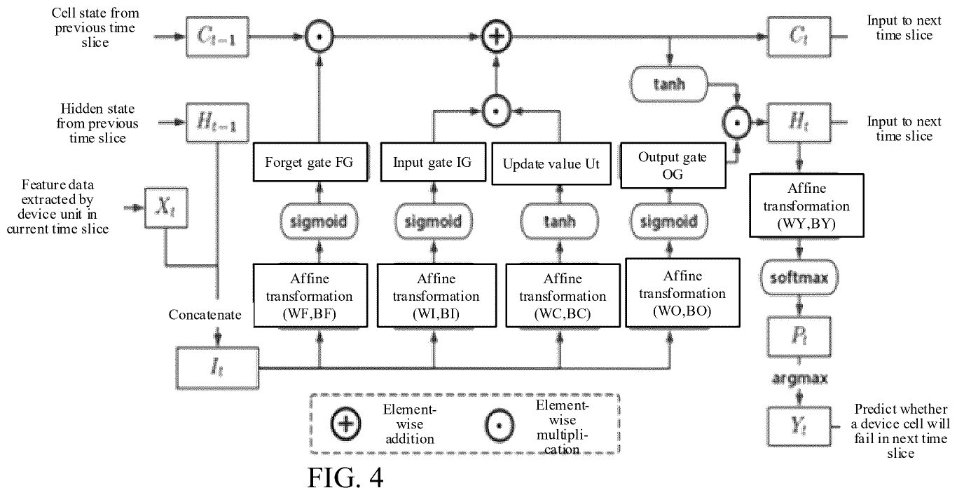

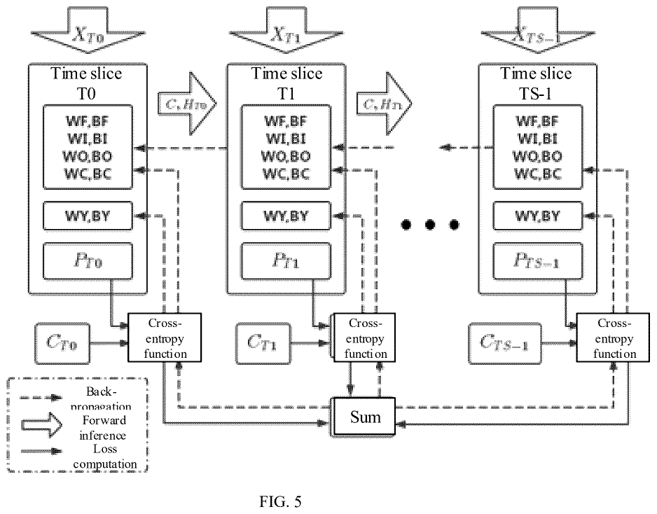

A specific embodiment of the present disclosure discloses a method for predicting a lifetime of a resistive random access memory chip. As shown in FIG. 1, the method includes the following steps.

In step S110, measured data of a memory cell in the RRAM chip performing read/write operations in a set/reset cycle under normal operating conditions is acquired.

In step S120, the measured data is processed to obtain input data X_{pt[i]}, where the input data X_{pt[i]} includes a forming voltage FV_{pt[i]}, a normalized resistance of set SR_{pt[i]}, a normalized resistance of reset RR_{pt[i]}, a local fluctuation of resistance of set SF_{pt[i]}, a local fluctuation of resistance of reset RF_{pt[i]}, a global fluctuation of resistance of set SVAR_{pt[i]}, a global fluctuation of resistance of reset RVAR_{pt[i]}, an average set voltage SVOL_{pt[i]}, and an average reset voltage RVOL_{pt[i]}.

In step S130, the input data X_{pt[i]} is input into a corresponding trained failure prediction model to obtain a binary classification prediction result indicating a true failure or a false failure of the memory cell in a next set/reset cycle t+1.

In step S140, if the binary classification prediction result indicates a false failure, a secondary determination is performed to obtain a prediction result indicating whether a false failure memory cell actually requires repair.

Specifically, acquiring measured data of a memory cell in the RRAM chip performing read/write operations in a set/reset cycle under normal operating conditions in step S110 includes the following steps.

In step (1), a forming voltage FVₚ for performing a forming operation on a brand-new RRAM chip is acquired.

In step (2), measured data of each memory cell in the formed RRAM chip in each set/reset cycle under normal operating conditions is recorded. A set/reset cycle includes: the memory cell completing a span of operations in the set/reset cycle, and then sequentially completing a first read operation consecutively and repeatedly for a predetermined number n of times, a set operation for one time, and a second read operation consecutively and repeatedly for a predetermined number n of times; a span of operations in the set/reset cycle includes the memory cell completing set/reset operations for a predetermined number N of times; the measured data Dₚₜ includes: a set voltage SVOL_RAW_{p[i]}, a reset voltage RVOL_RAW_{p[i]}, a resistance of set SR_RAW_{p[i]} and a resistance of reset RR_RAW_{p[i]} recorded within a span in the set/reset cycle, a resistance of reset sample R_{pr[i]} recorded when performing the first read operation consecutively and repeatedly in the set/reset cycle, a resistance of set sample R_{ps[i]} recorded when performing the second read operation consecutively and repeatedly in the set/reset cycle, a resistance of set R_{pset[i]} and a set voltage V_{pset[i]} recorded between the first read operation and the second read operation, and all output results O_{p[i]} in the set/reset cycle, which specifically includes:
i. writing the following data in real time into a flash memory peripheral to the RRAM chip: the resistance {RVOL_RAW_{p[i]}}t and the corresponding set voltage {SVOL_RAW_{p[i]}}ₜ for each memory cell upon the set operation being successful within a span in the set/reset cycle t, or the resistance {RVOL_RAW_{p[i]}}ₜ and the corresponding set voltage {SVOL_RAW_{p[i]}}ₜ for each memory cell upon the set operation failing for a predetermined number of times; and the resistance {RR_RAW_{p[i]}}ₜ and the corresponding reset voltage {RVOL_RAW_{p[i]}}ₜ for each memory cell upon the reset operation being successful, or the resistance {RR_RAW_{p[i]}}ₜ and the corresponding reset voltage {RVOL_RAW_{p[i]}}ₜ for each memory cell upon the reset operation failing for a predetermined number of times; as well as the output result {O_{p[i]}}_{ₜ}_{, where the set operation being successful includes the set operation being successful when being performed once, or the set operation being successful when being performed multiple times not more than the predetermined number of times, with the output result O indicating set success; and the reset operation being successful includes the reset operation being successful when being performed once, or the reset operation being successful when being performed multiple times not more than the predetermined number of times, with the output result O indicating reset success; and}
ii. writing the following data into a flash memory peripheral to the RRAM chip: the resistance of reset samples {R_{pr[i]}}ₜ recorded when performing the first read operation repeatedly in the set/reset cycle, the resistance of set samples {R_{ps[i]}}ₜ recorded when performing the second read operation repeatedly in the set/reset cycle, the resistance of sets {R_{pset[i]}}ₜ and the set voltages {V_{pset[i]}}ₜ recorded between the first read operations and the second read operations, and all output results {O_{p[i]}}ₜ in the set/reset cycle.

Specifically, processing the measured data to obtain input data X_{pt[i]} in step S120 includes the following.

(1) FV_{pt[i]} represents a forming voltage of the memory cell, a value of FV_{pt[i]} in a first set/reset cycle is set to the forming voltage FVₚ of the chip, and values in subsequent set/reset cycles are set to 0. The time slice corresponds to the set/reset cycle of the memory cell to be predicted. Specifically,

$${FV}_{p t [ i ]} = \{ \begin{matrix}FV , t = 0 \\ 0 , t > 0\end{matrix} ;$$

where t=0 corresponds to the first time slice, corresponding to a first set/reset cycle of the memory cell, and FV_{p0[i]}=FV=1.7 v; t∈[1, TS−1] corresponds to the second to (TS−1)^{th} time slices, corresponding to the second to (TS−1)^{th} set/reset cycles of the memory cell, i.e., FV_{pt[i]}={FV_{p[1]}, FV_{p[2]}, . . . , FV_{p[K-1]}}ₜ=0.

(2) SR_{pt[i]} represents a normalized resistance of set of the memory cell, obtained by dividing the mean of the raw resistance of set SR_RAW_{pt[i]} by a stable low resistance R_{low} of the RRAM chip. R_{low} is a low resistance of the memory cell during normal operation of the RRAM chip, and also a low resistance in the most stable state. SR_{pt[i]} is expressed as:

$${SR}_{p t [ i ]} = \frac{1}{N} \frac{1}{{R}_{low}} {\sum }_{j} {\{ {SR\_RAW}_{p [ i ]}^{j} \}}_{t}$$

where i represents an i^{th} memory cell, i∈[0, K−1]; j represents a j^{th} set operation within a span in the set/reset cycle, j∈[0, N−1]; t represents a t^{th} time slice corresponding to the current set/reset cycle; K is the total number of memory cells in the RRAM chip; N is the number of cycles of set/reset operations completed by the memory cell within a span in the set/reset cycle.

(3) RR_{pt[i]} represents a normalized resistance of reset of the memory cell, obtained by dividing the mean of the raw resistance of reset RR_RAW_{pt[i]} by a stable high resistance R_{high} of the RRAM chip. R_{high} is a high resistance of the memory cell during normal operation of the RRAM chip, and also a high resistance in the most stable state. RR_{pt[i]} is expressed as:

$${RR}_{p t [ i ]} = \frac{1}{N} \frac{1}{{R}_{high}} {\sum }_{m} {\{ {RR\_RAW}_{p [ i ]}^{m} \}}_{t}$$

where i represents the i^{th} memory cell, i∈[0, K−1]; j represents the j^{th} set operation within a span in the set/reset cycle, j∈[0, N−1]; t represents the t^{th} time slice corresponding to the current set/reset cycle; K is the total number of memory cells in the RRAM chip; N is the number of cycles of set/reset operations completed by the memory cell within a span in the set/reset cycle.

(4) SF_{pt[i]} represents a local fluctuation of the resistance of set of the memory cell, obtained by normalizing the resistance of set samples and then convolving the normalized resistance of set samples with a one-dimensional edge detection operator [−1, 0, 1]. SF_{pt[i]} is expressed as:

$${R}_{p {s}^{′} {t}_{[ i ]}} = {R}_{{pst}_{[ i ]}} / {R}_{low} \\ δ = [ - 1 , 0 , 1 ] \\ {SF}_{p {t}_{[ i ]}} = \sum δ ⊗ {\{ {R}_{{{ps}^{′}}_{[ i ]}} \}}_{t}$$

where

$${R}_{pst [ i ]} = {\{ {R}_{p s [ i ]}^{0} , {R}_{p s [ i ]}^{1} , …… , {R}_{p s [ i ]}^{n - 1} \}}_{t} ;$$

t represents the t^{th} time slice corresponding to the current set/reset cycle; K is the total number of memory cells in the RRAM chip; TS is the number of time slices covered by the training set for training the model; n is the number of resistance of set samples R_{pst[i]} obtained from the repeated read operations following a span in the set/reset cycle.

(5) RF_{pt[i]} represents a local fluctuation of the resistance of reset of the memory cell, obtained by normalizing the resistance of reset samples and then convolving the normalized resistance of reset samples with the one-dimensional edge detection operator [−1, 0, 1]. RF_{pt[i]} is expressed as:

$${R}_{{pr}^{′} {t}_{[ i ]}} = {R}_{{prt}_{[ i ]}} / {R}_{high} \\ δ = [ - 1 , 0 , 1 ] \\ {RF}_{p {t}_{[ i ]}} = \sum δ ⊗ {\{ {R}_{{{pr}^{′}}_{[ i ]}} \}}_{t}$$

where

$${R}_{prt [ i ]} = {\{ {R}_{pr [ i ]}^{0} , {R}_{pr [ i ]}^{1} , … , {R}_{pr [ i ]}^{n - 1} \}}_{t} ;$$

t represents the t^{th} time slice corresponding to the current set/reset cycle; K is the total number of memory cells in the RRAM chip; TS is the number of time slices covered by the training set for training the model; n is the number of resistance of reset samples R_{rt[i]} obtained from the repeated read operations following a span in the set/reset cycle.

(6) SVAR_{pt[i]} represents a global fluctuation of the resistance of set of the memory cell, obtained by normalizing each resistance in the resistance of set samples and then calculating a variance. SVAR_{pt[i]} is expressed as:

$${R}_{p {s}^{′} {t}_{[ i ]}} = {R}_{{pst}_{[ i ]}} / {R}_{low}$$

$${SVAR}_{p {t}_{[ i ]}} = {\{ \frac{{\sum }_{k} {( {R}_{p {s}_{[ i ]}^{′}}^{k} - \frac{{\sum }_{k} {R}_{p {s}_{[ i ]}^{′}}^{k}}{n} )}^{2}}{n} \}}_{t}$$

where

$${R}_{pst [ i ]} = {\{ {R}_{p s [ i ]}^{0} , {R}_{p s [ i ]}^{1} , … , {R}_{p s [ i ]}^{n - 1} \}}_{t} ;$$

t represents the t^{th} time slice corresponding to the current set/reset cycle; K is the total number of memory cells in the RRAM chip; k represents a k^{th} read operation in the n consecutive read operations following a set operation performed after n consecutive read operations following a span of operations in each set/reset cycle; n is the number of resistance of set samples R_{pst[i]} obtained from the repeated read operations following a span in the set/reset cycle.

(7) RVAR_{t[i]} represents a global fluctuation of the resistance of reset of the memory cell, obtained by normalizing each resistance in the resistance of reset samples and then calculating a variance. RVAR_{t[i]} is expressed as:

$${R}_{p {r}^{′} {t}_{[ i ]}} = {R}_{{prt}_{[ i ]}} / {R}_{high}$$

$${RVAR}_{p {t}_{[ i ]}} = {\{ \frac{{\sum }_{l} {( {R}_{p {r}_{[ i ]}^{′}}^{l} - \frac{{\sum }_{l} {R}_{p {r}_{[ i ]}^{′}}^{l}}{n} )}^{2}}{n} \}}_{t}$$

where

$${R}_{prt [ i ]} = {\{ {R}_{pr [ i ]}^{0} , {R}_{pr [ i ]}^{1} , … , {R}_{pr [ i ]}^{n - 1} \}}_{t} ;$$

t represents the t^{th} time slice corresponding to the current set/reset cycle; K is the total number of memory cells in the RRAM chip; l represents an l^{th} read operation in the n consecutive read operations following a span of operations in each set/reset cycle; n is the number of resistance of reset samples R_{rt[i]} obtained from the repeated read operations following a span in the set/reset cycle.

(8) SVOL_{pt[i]} represents an average set voltage of the memory cell, obtained by averaging all recorded set voltages within a span in the set/reset cycle. SVOL_{pt[i]} is expressed as:

$${SVOL}_{p t [ i ]} = \frac{1}{N} {\sum }_{j} {\{ {SVOL\_RAW}_{p [ i ]}^{j} \}}_{t}$$

where i represents the i^{th} memory cell, i∈[0, K−1]; j represents the j^{th} set operation within a span, j∈[0, N−1]; t represents the t^{th} time slice corresponding to the current set/reset cycle; K is the total number of memory cells in the RRAM chip; N is the number of cycles of set/reset operations completed by the memory cell within a span in the set/reset cycle.

(9) RVOL_{pt[i]} represents an average reset voltage of the memory cell, obtained by averaging all recorded reset voltages within a span in the set/reset cycle. RVOL_{pt[i]} is expressed as:

$${RVOL}_{p t [ i ]} = \frac{1}{N} {\sum }_{m} {\{ {RVOL\_RAW}_{p [ i ]}^{m} \}}_{t}$$

where i represents the i^{th} memory cell, i∈[0, K−1]; m represents an m^{th} reset operation within a span, m∈[0, N−1]; t represents the t^{th} time slice corresponding to the current set/reset cycle; K is the total number of memory cells in the RRAM chip; N is the number of cycles of set/reset operations completed by the memory cell within a span in the set/reset cycle.

Specifically, inputting the input data X_{pt[i]} into a corresponding trained failure prediction model to obtain a binary classification prediction result indicating a true failure or a false failure of the memory cell in a next set/reset cycle t+1 in step S130 includes the following steps.

In step (1), the preprocessed data X_{pt[i]} obtained after a set/reset cycle is input into a trained model M_{trained[i]}.

In step (2), Y_{t[i]} is output by the trained model M_{trained[i]} as the prediction result for the memory cell in the next set/reset cycle t+1, where if Y_{t[i]}=1, the prediction result indicates a false failure of the memory cell in the next time slice; and if Y_{t[i]}=0, the prediction result indicates a true failure of the memory cell in the next time slice.

Specifically, the trained failure prediction model in step S130 is obtained by the following steps.

In step S210, the raw data Dₜ={D_{t[0]}, D_{t[1]}, . . . , D_{t[K-1]}} is acquired, where D_{t[i]}={FV, SVOL_RAW_{[i]}, RVOL_RAW_{[i]}, SR_RAW_{[i]}, RR_RAW_{[i]}, R_{r[i]}, R_{s[i]}, R_{set[i]}, V_{set[i]}}ₜ, t represents a t^{th} simulation cycle, t∈[0, T−1], i represents an i^{th} memory cell, i∈[0, K−1], and K is the total number of memory cells in the RRAM chip.

Specifically, FV represents a forming voltage;

$${SVOL\_RAW}_{t [ i ]} = {\{ {SVOL\_RAW}_{[ i ]}^{0} , {SVOL\_RAW}_{[ i ]}^{1} , … , {SVOL\_RAW}_{[ i ]}^{N - 1} \}}_{t} and$$

$${RVOL\_RAW}_{t [ i ]} = {\{ {RVOL\_RAW}_{[ i ]}^{0} , {RVOL\_RAW}_{[ i ]}^{1} , … , {RVOL\_RAW}_{[ i ]}^{N - 1} \}}_{t}$$

respectively represent a set voltage and a reset voltage for each memory cell during N set/reset cycles within a span in each simulation cycle of all TS simulation cycles;

$${SR\_RAW}_{t [ i ]} = {\{ {SR\_RAW}_{[ i ]}^{0} , {SR\_RAW}_{[ i ]}^{1} , … , {SR\_RAW}_{[ i ]}^{N - 1} \}}_{t} and$$

$${RR\_RAW}_{t [ i ]} = {\{ {RR\_RAW}_{[ i ]}^{0} , {RR\_RAW}_{[ i ]}^{1} , … , {RR\_RAW}_{[ i ]}^{N - 1} \}}_{t}$$

respectively represent N raw resistance of sets and N raw resistance of resets read after N set/reset cycles for each memory cell within a span in each simulation cycle of all TS simulation cycles;

$${R}_{rt [ i ]} = {\{ {R}_{r [ i ]}^{0} , {R}_{r [ i ]}^{1} , … , {R}_{r [ i ]}^{n - 1} \}}_{t} and {R}_{st [ i ]} = {\{ {R}_{s [ i ]}^{0} , {R}_{s [ i ]}^{1} , … , {R}_{s [ i ]}^{n - 1} \}}_{t}$$

respectively represent the resistance of resets obtained from n consecutive read operations performed after a span of operations and the resistance of sets obtained from n consecutive read operations performed after a further set operation in each simulation cycle of all T simulation cycles; where t∈[0, T−1], t represents the t^{th} simulation cycle, i represents the i^{th} memory cell, i∈[0, K−1], and K is the total number of memory cells in the RRAM chip.

Specifically, the raw data Dₜ is obtained through a read/write circuit by executing the following steps using test software.

In step (1), a forming operation is performed on the RRAM chip to switch each memory cell in the chip into a conductive state, and the forming voltage FV is recorded. Specifically, a forming operation is performed on a brand-new RRAM chip by applying a forming voltage pulse to a source line terminal (SL terminal) of a memory array of the chip to switch each memory cell in the chip into a conductive state, and the forming voltage FV=1.7V is recorded. The forming voltage FV is set according to the forming voltage of the chip used during actual prediction, with a range of 1.5 v~2.5 v. Preferably, the forming voltage pulse is 1.7V/3 μs, with FV=1.7 v.

In step (2), a forming result is verified, and a forming resistance R_{f} and an output result for each memory cell are recorded. Specifically, the forming result is verified through a read operation, in which a read voltage is applied to a bit line terminal (BL terminal) of the memory array of the chip, and the resistance of each memory cell is read to determine whether it falls within a resistance range for successful forming operation. If the read resistance falls within the resistance range for successful forming operation, the output result O_{[i]} is “forming success” and the resistance R_{f[i]} is recorded, then step (3) is executed; otherwise, the output result O_{[i]} is “forming fail” and the resistance R_{f[i]} is recorded, then step (3) is executed. Here, i represents the i^{th} memory cell. Optionally, if the read device resistance decreases from MΩ level to KΩ level, “forming success” is output. Preferably, the resistance range for successful forming operation is below 700 KΩ. The read voltage is set according to the read voltage of the chip used during actual prediction, with a range of 0.1 v~0.4 v. Preferably, the read voltage is 0.3 v.

In step (3), a set operation is performed on the formed chip, the resistance SR_RAW and the corresponding set voltage SVOL_RAW for each memory cell upon the set operation being successful, or the resistance SR_RAW and the corresponding set voltage SVOL_RAW for each memory cell upon the set operation failing for a predetermined number of times, along with an output result O are recorded. The set operation being successful includes the set operation being successful when being performed once, or the set operation being successful when being performed multiple times not more than the predetermined number of times. Specifically, this includes steps (a) to (c) as follows.

In step (a), a set operation is performed on the memory array of the formed chip by applying a set operation voltage pulse to the bit line terminal (BL terminal) of a memory cell to be set in the memory array of the chip. An initial value of the set operation voltage is set according to an initial value of the set operation voltage of the chip used during actual prediction. Initially, all memory cells are memory cells to be set. The set operation voltage is in a range of 0.8 v~2.5 v. Preferably, the initial set operation voltage is a set operation voltage at which the RRAM chip may operate stably, and the initial set operation pulse is 1.2 v/700 ns.

In step (b), a validity of the set operation is verified, and the resistance and the current set voltage for each memory cell upon the set operation being successful are recorded. This is done by reading the resistance of each memory cell after step (a) and determining whether it falls within the resistance range for successful set operation. If the read resistance falls within the resistance range for a valid set operation, the output result O_{[i]} is “set success”, and the resistance SR_RAW_{[i]} and the current set voltage SVOL_RAW_{[i]} are recorded, where i represents the i^{th} memory cell, then step (4) is executed; otherwise, the memory cell remains as a memory cell to be set, and step (c) is executed. Preferably, the resistance range for successful set operation is less than a stable low resistance R_{low}, which is a low resistance of the memory cell when the RRAM chip operates normally and is also the low resistance in the most stable state. Preferably, the value of R_{low} is 35 kΩ.

In step (c), the set operation is performed repeatedly until set fail occurs, and the resistance and the current set voltage for each memory cell upon the set fail occurring are recorded. Specifically, the set operation voltage is gradually increased by adding a predetermined increment to a current value, and steps (a) and (b) are repeatedly executed until the set operation is performed for a predetermined number of times. The output result O_{[i]} is “set fail”, and the resistance

$${SR\_RAW}_{[ i ]}^{0}$$

and the current set voltage

$${SVOL\_RAW}_{[ i ]}^{0}$$

are recorded, then step (4) is executed. Here, i represents the i^{th} memory cell, i∈[0, K−1], and K is the total number of memory cells in the RRAM chip. Optionally, the predetermined increment is an integer multiple of 0.05 v in the range of 1~10. Preferably, the predetermined increment is 0.1 v, and the predetermined number of times that the set operation is performed is 7.

In step (4), a reset operation is performed on the formed chip, and a resistance RR_RAW and a corresponding reset voltage RVOL_RAW for each memory cell upon the reset operation being successful, or the resistance RR_RAW and the corresponding reset voltage RVOL_RAW for each memory cell upon the reset operation failing for a predetermined number of times, along with an output result O are recorded. The reset operation being successful includes the reset operation being successful when being performed once, or the reset operation being successful when being performed multiple times not more than the predetermined number of times. Specifically, this includes steps (a) to (c) as follows.

In step (a), a reset operation is performed on the memory array of the chip by applying a reset voltage pulse to the source line terminal (SL terminal) of the memory cell to be reset. An initial value of the reset voltage is set according to an initial value of the reset operation voltage of the chip used during actual prediction. Initially, all memory cells are memory cells to be reset. The reset operation voltage is in a range of 1 v~3 v. Preferably, the initial reset operation voltage is a set operation voltage at which the RRAM chip may operate stably, and the initial reset operation pulse is 1.6V/700 ns.

In step (b), a validity of the reset operation is verified, and the resistance and the current reset voltage for each memory cell upon the reset operation being successful are recorded. This is done by reading the resistance of each memory cell after step (a) and determining whether it falls within a resistance range for successful reset operation. If the read resistance falls within the resistance range for valid reset, the output result O_{[i]} is “reset success”, and the resistance

$${RR\_RAW}_{[ i ]}^{0}$$

and the current reset voltage

$${RVOL\_RAW}_{[ i ]}^{0}$$

are recorded, where i represents the i^{th} memory cell, i∈[0, K−1], and K is the total number of memory cells in the RRAM chip, then step (5) is executed; otherwise, step (c) is executed. Preferably, the resistance range for successful reset operation is greater than a stable high resistance R_{high}, which is a high resistance of the memory cell when the RRAM chip operates normally and is also a high resistance in the most stable state. Preferably, a value of R_{high} is 200 KΩ.

In step (c), the reset operation is performed repeatedly until set fail occurs, and the resistance and the current reset voltage for each memory cell upon the reset fail occurring are recorded. Specifically, the reset operation voltage is gradually increased by adding a predetermined increment to a current value, and steps (a) and (b) are repeatedly executed until the reset operation is performed for a predetermined number of times. The output result O_{[i]} is “reset fail”, and the resistance

$${RR\_RAW}_{[ i ]}^{0}$$

and the current reset voltage

$${RVOL\_RAW}_{[ i ]}^{0}$$

are recorded, then step (5) is executed. Here, i represents the i^{th} memory cell, i∈[0, K−1], and K is the total number of memory cells in the RRAM chip. Optionally, the predetermined increment is an integer multiple of 0.05 v in the range of 1~10. Preferably, the predetermined increment is 0.1 v, and the predetermined number of times that the reset operation is performed is 7.

In step (5), the set operation and the reset operation are repeatedly performed to complete a predetermined number of cycles N in a span. Specifically, step (3) and step (4) are repeatedly performed until the predetermined number of cycles is completed, which is defined as a completion of a span, then step (6) is executed. Preferably, the predetermined number of cycles is set to 500.

In step (6), a read operation is repeatedly performed on the chip memory array for a predetermined number of times n to obtain resistance of reset samples Rr for computing a resistance of reset fluctuation. Specifically, a read operation is performed to read and record the resistance of all memory cells, and the read operation is repeatedly performed n times to obtain n resistance records for each memory cell. The value of n should be a trade-off between obtaining the resistance fluctuation and reducing the impact on the lifetime of memory cells. Preferably, the value of n is 100,

$${R}_{r [ i ]}^{100} = \{ {R}_{r [ i ]}^{0} , {R}_{r [ 1 ]}^{1} , … … , {R}_{r [ i ]}^{99} \} ,$$

where i represents the i^{th} memory cell, i∈[0, K−1], and K is the total number of memory cells in the RRAM chip.

In step (7), a set operation is performed on the chip, the resistance Rₛₑₜ and the current set voltage Vₛₑₜ for each memory cell upon the set operation being successful, or the resistance Rₛₑₜ and the current set voltage Vₛₑₜ for each memory cell upon the set operation failing for a predetermined number of times, along with an output result O are recorded. The set operation being successful includes the set operation being successful when being performed once, or the set operation being successful when being performed multiple times not more than the predetermined number of times. Specifically, this includes steps (a) to (c) as follows.

In step (a), a set operation is performed on the memory array of the chip by applying a set operation voltage pulse to the bit line terminal (BL terminal) of a memory cell to be set in the memory array of the chip. An initial value of the set operation voltage is set according to an initial value of the set operation voltage of the chip used during actual prediction. Initially, all memory cells are memory cells to be set. The set operation voltage is in a range of 0.8 v~2.5 v. Preferably, the initial set operation voltage pulse is 1.2 v/700 ns.

In step (b), a validity of the set operation is verified, and the resistance and the current set voltage for each memory cell upon the set operation being successful are recorded. This is done by reading the resistance of each memory cell after step (a) and determining whether it falls within the resistance range for successful set operation. If the read resistance falls within the resistance range for a valid set operation, the output result O_{[i]} is “set success”, and the resistance

$${R}_{set [ i ]}^{0}$$

and the current set voltage

$${V}_{ set [ i ]}^{0}$$

are recorded, where i represents the i^{th} memory cell, then step (8) is executed; otherwise, the memory cell remains as a memory cell to be set, and step (c) is executed. Preferably, the resistance range for successful set operation is less than a stable low resistance R_{low}, which is a low resistance of the memory cell when the RRAM chip operates normally and is also a low resistance in the most stable state. Preferably, the value of R_{low} is 35 kΩ.

In step (c), the set operation is performed repeatedly until set fail occurs, and the resistance Rₛₑₜ and the current set voltage Vₛₑₜ for each memory cell upon the set fail occurring are recorded. Specifically, the set operation voltage is gradually increased by adding a predetermined increment to a current value, and steps (a) and (b) are repeatedly executed until the set operation is performed for a predetermined number of times. The output result O_{[i]} is “set fail”, and the resistance R_{set[i]} and the current set voltage V_{set[i]} are recorded, then step (8) is executed. Here, i represents the i^{th} memory cell, i∈[0, K−1], and K is the total number of memory cells in the RRAM chip. Optionally, the predetermined increment is an integer multiple of 0.05 v in the range of 1~10. Preferably, the predetermined increment is 0.1 v, and the predetermined number of times that the set operation is performed is 7.

In step (8), a read operation is repeatedly performed for the predetermined number of times n to obtain resistance of set samples Rₛ for computing a resistance of set fluctuation. Specifically, a read operation is performed to read and record the resistance of all memory cells, and the read operation is repeatedly performed n times to obtain n resistance records for each memory cell. The value of n should be a trade-off between obtaining the resistance fluctuation and reducing the impact on the lifetime of memory cells. Preferably, the value of n is 100,

$${R}_{s [ i ]}^{100} = \{ {R}_{s [ i ]}^{0} , {R}_{s [ i ]}^{1} , … … , {R}_{s [ i ]}^{99} \} ,$$

where i represents the i^{th} memory cell, i∈[0, K−1], and K is the total number of memory cells in the RRAM chip.

In step (9), steps (3) to (8) are defined as a simulation cycle, and T simulation cycles are performed to obtain the raw data Dₜ={FV, SVOL_RAW, RVOL_RAW, SR_RAW, RR_RAW, Rᵣ, Rₛ, Rₛₑₜ, Vₛₑₜ}ₜ. Preferably, if the predetermined number of cycles N in a span is 500 and the predetermined number of times n of repeated read operations performed after a span is 100, then

$${D}_{t [ i ]} = {\{ FV , {SVOL\_RAW}_{[ i ]}^{500} , {RVOL\_RAW}_{[ i ]}^{500} , {SR\_RAW}_{[ i ]}^{500 )} , {RR\_RAW}_{[ i ]}^{500} , {R}_{r [ i ]}^{100} , {R}_{s [ 1 ]}^{100} , {R}_{s e t [ i ]} , {V}_{s e t [ 1 ]} \}}_{t} ,$$

where t represents a t^{th} simulation cycle, t∈[0, T−1], i represents the i^{th} memory cell, i∈[0, K−1], and K is the total number of memory cells in the RRAM chip. Preferably, raw data from 25 simulation cycles is obtained, i.e., T=25.

A span of operations in a simulation cycle is used to simulate the actual set/reset process of the chip, and the predetermined number of cycles is determined according to the endurance evaluation requirements. The repeated operations performed after a span is used to obtain the resistance data samples for computing the resistance fluctuation.

Optionally, the RRAM chip may be placed on a test board of a chip tester, and the raw data is acquired using test software, thereby achieving automatic acquisition of raw data.

Optionally, the model of the chip tester may be ADVANTEST V93000.

In step S220, the raw data is preprocessed to obtain nine-dimensional input data Xₜ={FVₜ, SRₜ, RRₜ, SFₜ, RFₜ, SVARₜ, RVARₜ, SVOLₜ, RVOLₜ}, including the following steps:

(1) FVₜ represents the forming voltage, a value of which in a first time slice is set to the FV in the raw data, and the remaining values of which in subsequent time slices are set to 0. The time slice is an equal-period interval on the time axis of the RRAM chip lifetime model. The t^{th} time slice corresponds to the read operation, set operation and reset operation in the t^{th} simulation cycle under the simulated environment. The time slice immediately after the forming operation when the chip is freshly manufactured is denoted as T₀, followed sequentially by T₁, T₂ . . . Tₜ, . . . T_{T-1}. Specifically, FVₜ={FV_{[1]}, FV_{[2]}, . . . , FV_{[K-1]}}ₜ, where t=0 corresponds to the first time slice T0 for model training, FV₀={FV_{[0]}, FV_{[1]}, . . . , FV_{[K-1]}}₀=FV; t∈[1, T−1] corresponds to the second to (T−1)^{th} time slices for model training, FVₜ={FV_{[1]}, FV_{[2]}, . . . , FV_{[K]}}ₜ=0.

(2) SRₜ represents a normalized resistance of set, which is obtained by dividing the mean of the raw resistance of set SR_RAW by the stable low resistance R_{low} of the RRAM chip. Here, R_{low} is the low resistance of the memory cell when the RRAM chip operates normally, which is also the low resistance in the most stable state. In this embodiment, the value of R_{low} is 35 kΩ. Specifically, SRₜ={SR_{[0]}, SR_{[1]}, . . . , SR_{[K-1]}}ₜ, where SR_{t[i]} represents the normalized resistance of set of the i^{th} memory cell in the t^{th} cycle, expressed as:

$$S {R}_{t [ i ]} = \frac{1}{N} \frac{1}{{R}_{low}} {\sum }_{j} {\{ {SR\_RAW}_{[ i ]}^{j} \}}_{t}$$

where i represents the i^{th} memory cell, i∈[0, K−1]; j represents the j^{th} set operation in a span, j∈[0, N−1]; t represents the t^{th} simulation cycle or the t^{th} time slice under the simulated environment, t∈[0, T−1]; K is the total number of memory cells in the RRAM chip, T is the number of simulation cycles covered by the raw data, and N is the number of cycles of set/reset operations for the memory cells completed in a span in a simulation cycle.

(3) RRₜ represents a normalized resistance of reset, which is obtained by dividing the mean of the raw resistance of reset RR_RAW by the stable high resistance R_{high} of the RRAM chip. Here, R_{high} represents the high resistance of the memory cell when the RRAM chip operates normally, which is also the high resistance in the most stable state. In this embodiment, the value of the stable high resistance R_{high} is 200 KΩ. Specifically, RRₜ={RR_{[0]}, RR_{[1]}, . . . , RR_{[K-1]}}ₜ, where RR_{t[i]} represents the normalized resistance of reset of the i^{th} memory cell in the t^{th} cycle of the raw resistance of reset RR_RAW_{t[i]}, expressed as:

$$R {R}_{t [ i ]} = \frac{1}{N} \frac{1}{{R}_{high}} {\sum }_{m} {\{ {RR\_RAW}_{[ i ]}^{m} \}}_{t}$$

where i represents the i^{th} memory cell, i∈[0, K−1]; m represents an m^{th} reset operation in a span, m∈[0, N−1]; t represents the t^{th} cycle or the t^{th} time slice under the simulated environment, t∈[[0, T−1]; K is the total number of memory cells in the RRAM chip, T is the number of simulation cycles covered by the raw data, and N is the number of cycles of set/reset operations for the memory cells completed in a span in the simulation cycle.

(4) SFₜ represents a local fluctuation of the resistance of set of a memory cell, obtained by normalizing the resistance of set samples and then convolving the normalized resistance of set samples with a one-dimensional edge detection operator [−1, 0, 1]. Specifically, Rₛ={SF_{[0]}, SF_{[1]}, . . . , SF_{[K-1]}}ₜ, where SF_{t[i]} represents the local fluctuation of the resistance of set samples R_{st[i]} of the memory cell obtained from n consecutive read operations following a set operation performed after n consecutive read operations following a span of operations in each simulation cycle. SF_{t[i]} is obtained by normalizing the resistance of set samples R_{st[i]} and then convolving the normalized resistance of set samples with the one-dimensional edge detection operator [−1, 0, 1], expressed as:

$${R}_{{s}^{′} t [ 1 ]} = {R}_{st [ i ]} / {R}_{low}$$

$$δ = [ - 1 , 0 , 1 ]$$

$${SF}_{t [ i ]} = \sum δ ⊗ {\{ {R}_{{s}^{′} [ i ]} \}}_{t}$$

$${SF}_{t} = {\{ {SF}_{[ 1 ]} , {RF}_{[ 2 ]} , … … , {SF}_{[ K - 1 ]} \}}_{t}$$

where

$${R}_{s t [ i ]} = {\{ {R}_{s [ i ]}^{0} , {R}_{s [ 1 ]}^{1} , … … , {R}_{s [ i ]}^{n - 1} \}}_{t} ,$$

t represents the t^{th} cycle or the t^{th} time slice under the simulated environment, t∈[0, T−1]; K is the total number of memory cells in the RRAM chip, T is the number of simulation cycles covered by the raw data, and n is the number of resistance of set samples R_{st[i]} obtained from repeated read operations following a span in a simulation cycle.

(5) RFₜ represents a local fluctuation of the resistance of reset of the memory cell, obtained by normalizing the resistance of reset samples and then convolving the normalized resistance of reset samples with a one-dimensional edge detection operator [−1, 0, 1]. Specifically, RFₜ={RF_{[0]}, RF_{[1]}, . . . , RF_{[K-1]}}ₜ, where RF_{t[i]} represents the local fluctuation of the resistance R_{rt[i]} of the memory cell obtained from n consecutive read operations following a span of operations in each simulation cycle, and is obtained by normalizing the resistance R_{rt[i]} and then convolving the normalized resistance R_{rt[i]} with the one-dimensional edge detection operator [−1, 0, 1], expressed as:

$${R}_{{r}^{′} t [ 1 ]} = {R}_{rt [ i ]} / {R}_{high}$$

$$δ = [ - 1 , 0 , 1 ]$$

$${RF}_{t [ i ]} = \sum δ ⊗ {\{ {R}_{{r}^{′} [ i ]} \}}_{t}$$

$${RF}_{t} = {\{ {RF}_{[ 1 ]} , {RF}_{[ 2 ]} , … … , {RF}_{[ K - 1 ]} \}}_{t}$$

where

$${R}_{rt [ i ]} = {\{ {R}_{r [ i ]}^{0} , {R}_{r [ 1 ]}^{1} , … … , {R}_{r [ i ]}^{n - 1} \}}_{t} ;$$

t represents the t^{th} cycle or the t^{th} time slice under the simulated environment, t∈[0, T−1]; K is the total number of memory cells in the RRAM chip, T is the number of simulation cycles covered by the raw data, and n is the number of resistance of reset samples R_{rt[i]} obtained from repeated read operations following a span in a simulation cycle.

(6) SVARₜ represents a global fluctuation of the resistance of set of the memory cell, obtained by normalizing each resistance in the resistance of set samples and then calculating the variance. Specifically, SVARₜ={SVAR_{[0]}, SVAR_{[1]}, . . . , SVAR_{[K-1]}}ₜ, where SVARₜ represents the global fluctuation of the resistance R_{st[i]} of the memory cell obtained from n consecutive read operations following a set operation performed after n consecutive read operations following a span of operations in each simulation cycle, and is obtained by normalizing each resistance in R_{st[i]} and then calculating the variance, expressed as:

$${R}_{{s}^{′} t [ 1 ]} = {R}_{st [ i ]} / {R}_{l o w}$$

$${SVAR}_{t [ i ]} = {\{ \frac{{\sum }_{k} {( {R}_{{s}^{′} [ i ]}^{k} - \frac{{\sum }_{k} {R}_{{s}^{′} [ i ]}^{k}}{n} )}^{2}}{n} \}}_{t}$$

$${SVAR}_{t} = {\{ {SVAR}_{[ 1 ]} , {SVAR}_{[ 2 ]} , … … , {SVAR}_{[ K - 1 ]} \}}_{t}$$

where

$${R}_{s t [ i ]} = {\{ {R}_{s [ i ]}^{0} , {R}_{s [ i ]}^{1} , … … , {R}_{s [ i ]}^{n - 1} \}}_{t} ;$$

t represents the t^{th} cycle or the t^{th} time slice under the simulated environment, t∈[0, T−1]; K is the total number of memory cells in the RRAM chip, T is the number of simulation cycles covered by the raw data; k represents a k^{th} read operation in the n consecutive read operations following a set operation performed after n consecutive read operations following a span of operations in each simulation cycle; and n is the number of resistance of set samples R_{st[i]} obtained from repeated read operations following a span in the simulation cycle.

(7) RVARₜ represents a global fluctuation of the resistance of reset of the memory cell, obtained by normalizing each resistance in the resistance of reset samples and then calculating the variance. Specifically, RVARₜ={RVAR_{[0]}, RVAR_{[1]}, . . . , RVA_{R[K-1]}}ₜ, where RVARₜ represents the global fluctuation of the resistance R_{rt[i]} for a memory cell obtained from n consecutive read operations following a span of operations in each simulation cycle, and is obtained by normalizing each resistance in R_{rt[i]} and then calculating the variance, expressed as:

$${R}_{{r}^{′} t [ i ]} = {R}_{rt [ i ]} / {R}_{high}$$

$${RVAR}_{t [ i ]} = {\{ \frac{{\sum }_{l} {( {R}_{{r}^{′} [ i ]}^{1} - \frac{{\sum }_{1} {R}_{{r}^{′} [ i ]}^{1}}{n} )}^{2}}{n} \}}_{t}$$

$${RVAR}_{t} = {\{ {RVAR}_{[ 1 ]} , RVA {R}_{[ 2 ]} , … … , {RVAR}_{[ K - 1 ]} \}}_{t}$$

where

$${R}_{rt [ i ]} = {\{ {R}_{r [ i ]}^{0} , {R}_{r [ i ]}^{1} , … … , {R}_{r [ i ]}^{n - 1} \}}_{t} ;$$

t represents the t^{th} cycle or the t^{th} time slice under the simulated environment, t∈[0, T−1]; K is the total number of memory cells in the RRAM chip, T is the number of simulation cycles covered by the raw data; l represents an l^{th} read operation in the n consecutive read operations performed on the memory cell following a span of operations in each simulation cycle; n is the number of resistance of reset samples R_{rt[i]} obtained from repeated read operations following a span in the simulation cycle.

(8) SVOLₜ represents an average set voltage for the memory cell, obtained by calculating the mean of all recorded set voltages within a span in the simulation cycle. Specifically, SVOLₜ={SVOL_{[0]}, SVOL_{[l]}, . . . , SVOL_{[K-1]}}ₜ, where SVOLₜ represents the average set voltage for the memory cell during the set operations in a span of operations in the t^{th} simulation cycle, expressed as.

$$S V O {L}_{t [ i ]} = \frac{1}{N} {\sum }_{j} {\{ {SVOL\_RAW}_{[ i ]}^{j} \}}_{t}$$

where i represents the i^{th} memory cell, i∈[0, K−1]; j represents the j^{th} set operation in a span, j∈[0, N−1]; t represents the t^{th} cycle or the t^{th} time slice under the simulated environment, t∈[0, T−1]; K is the total number of memory cells in the RRAM chip, T is the number of simulation cycles covered by the raw data; N is the number of cycles of set/reset operations for the memory cell completed within a span in the simulation cycle.

(9) RVOLₜ represents an average reset voltage for the memory cell, obtained by calculating the mean of all recorded reset voltages within a span in the simulation cycle. Specifically, RVOLₜ={RVOL_{[0]}, RVOL_{[1]}, . . . , RVOL_{[K-1]}}, where RVOLₜ represents the average reset voltage of the reset operations for the memory cell in a span of operations in the t^{th} simulation cycle, expressed as:

$$R V O {L}_{t [ i ]} = \frac{1}{N} {\sum }_{m} {\{ {RVOL\_RAW}_{[ i ]}^{m} \}}_{t}$$

where i represents the i^{th} memory cell, i∈[0, K−1]; m represents the m^{th} reset operation in a span, m∈[0, N−1]; t represents the t^{th} cycle or the t^{th} time slice under the simulated environment, t∈[0, T−1]; K is the total number of memory cells in the RRAM chip, T is the number of simulation cycles covered by the raw data; N is the number of cycles of set/reset operations for the memory cell completed within a span in the simulation cycle.

In step S230, a dataset D₁ having a data structure of K×9×T is constructed according to the nine-dimensional input data, and binary classification labeling of true failure or false failure is performed on the dataset D₁ to obtain a model training dataset D₂ consisting of external inputs Xₜ of a model M and corresponding labels Cₜ.

Specifically, the number of cycles T covered by the raw data is defined as a training span, then each training span includes T time slices. T matrices of size K×9 are constructed on a per-time-slice basis as an external input X to model M, where X={X₀, X₁, . . . , X_{T-1}}, Xₜ={X_{[0]}, X_{[1]}, . . . , X_{[K-1]}}ₜ, and Xₜ represents the nine-dimensional data of K memory cells in the t^{th} time slice.

Specifically, performing binary classification labeling of true failure or false failure on the dataset D₁ to obtain a model training dataset D₂ consisting of external inputs Xₜ of a model M and corresponding labels Cₜ includes:
(1) determining a state result S_{t[i]} of the memory cell in a (t+1)^{th} simulation cycle according to an output result O_{t+1[i]} within each span in the (t+1)^{th} simulation cycle, where: a) if O_{t+1[i]} does not include “set success” or “reset success”, then the state result St+1[i]=0, indicating that the memory cell undergoes a true failure in the (t+1)^{th} simulation cycle; b) in other cases except a), the state result S_{t+1[i]}=1, indicating that the memory cell undergoes a false failure in the (t+1)^{th} simulation cycle; and
(2) assigning a corresponding label

$${c}_{t [ i ]} = {[ {c}_{i}^{0} , {c}_{i}^{1} ]}_{t}$$

to X_{t[i]} according to the state result S_{t+1[i]}, where the superscripts 0 and 1 are indices of a two-dimensional vector, a labeling method includes: i. if the state result S_{t+1[i]}=0, a corresponding label c_{t[i]}=[1, 0]ₜ is assigned to X_{t[i]}; and ii. if the state result S_{t+1[i]}=1, a corresponding label c_{t[i]}=[0, 1]ₜ is assigned to X_{t[i]};
(3) on a per-time-slice basis, T matrices of size K×2 are constructed as the labels Cₜ corresponding to the external input Xₜ of the model M, where Cₜ={C_{[0]}, C_{[1]}, . . . , C_{[K-1]}}ₜ; Xₜ and the corresponding label Cₜ form model training data D_{2_t}. On a per-time-slice basis, T model training data D_{2_t} are constructed as the model training dataset D₂, where D₂={D_{2_0}, D_{2_1}, . . . , D_{2_T-1}}.

In step 240, the model M is trained using the model training dataset D₂, where the model M includes K LSTM replica models {M_{[0]}, M_{[1]}, . . . , M_{[K-1]}} with identical parameters. Different replica models are used to independently perform forward inference and error computation for the K memory cells.

Specifically, training the model M includes the following steps.

In step S310, the model training dataset D₂ is divided by time slices into a training dataset Dₜᵣₐᵢₙ and a test dataset Dₜₑₛₜ; where the data of first TS time slices of D₂ are divided into the training dataset, Dₜᵣₐᵢₙ={D_{2_0}, D_{2_1}, . . . , D_{2_TS-1}}, and the data of the remaining T-TS time slices are divided into the test dataset, Dₜₑₛₜ={D_{2_TS-1}, D_{2_TS}, . . . , D_{2_T-1}}. Preferably, T=25 and TS=20.

In step S320, the model M is initialized by setting initial values of the cell state and hidden state of the LSTM to 0; and the model M is constructed as K LSTM replica models {M_{[0]}, M_{[1]}, . . . , M[_{K-1}]} with identical parameters.

In step S330, for each time slice in Dₜᵣₐᵢₙ, the input data {D₂}ₜ is split into K nine-dimensional vectors Xₜ={X_{[0]}, X_{[1]}, . . . , X_{[K-1]}}ₜ, the split data are sequentially input in time-slice order into the K LSTM replica models M={M_{[0]}, M_{[1]}, . . . , M_{[K-1]}} with identical parameters for model training to obtain K trained replica models. Any one of the K trained replica models may be selected as the final model M_{trained}, which is then tested using Dₜₑₛₜ.

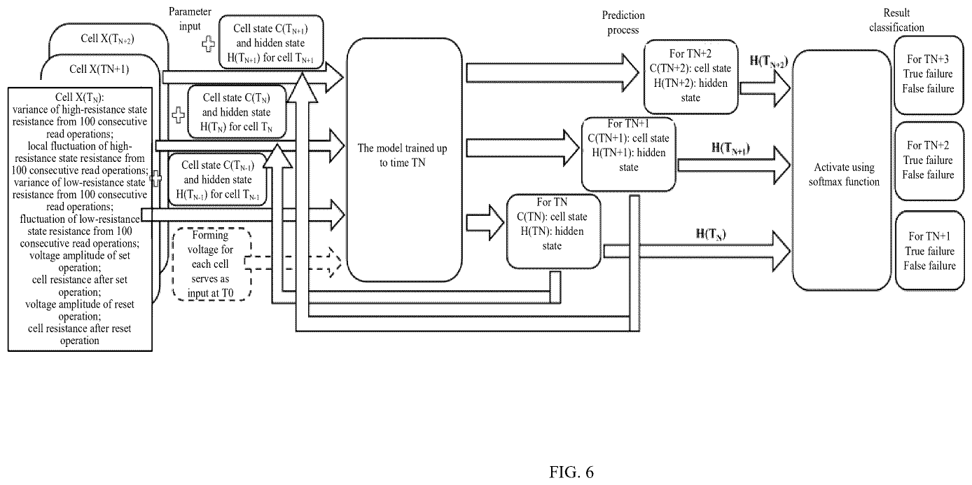

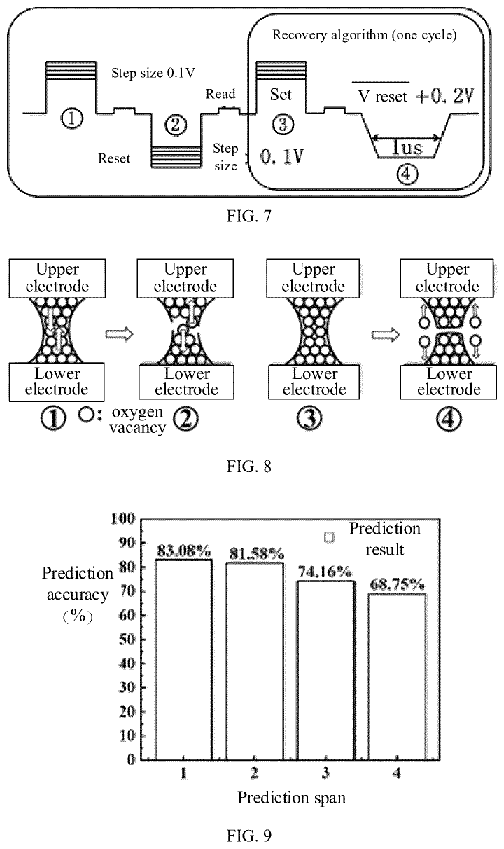

More specifically, the model M in step S230 and step S240 is constructed based on a Long Short-Term Memory neural network (LSTM), as shown in FIG. 6. The LSTM is used to predict important events that have long intervals and delays in time series. For an RRAM chip lifetime prediction task, a state change process of the memory cells of the RRAM chip is modeled along the time axis. The interval of events in the time series is defined as a time slice. Each time slice includes repeated read operations, set operations, and set/reset cycling operations for all memory cells of the RRAM chip in a simulation cycle under the simulated environment, or repeated read operations, set operations, and set/reset cycling operations for each memory cell in a set/reset cycle under actual operating conditions. The time slice after the forming operation and immediately after factory shipment is defined as T0, followed sequentially by T1, T2 . . . Tt, T(t+1) . . . .

The Long Short-Term Memory neural network (LSTM) may be regarded as a time-iterative cell during computation. The cell parameters include a cell state Cₜ, a hidden state Hₜ, and a state update value Uₜ. The cell state Cₜ is used to perform a memory function, incorporating the cumulative impact of neural network inputs from previous time slices into the current prediction. The hidden state Hₜ is used to compute a prediction classification result for the current time slice and to update the neural network input for the next time slice. The state update value Uₜ is used to transform the neural network input for the current time slice into data that may participate in neural network computation. For the task in this embodiment, Cₜ, Hₜ, and Uₜ have data structures of 200-dimensional vectors.

The Long Short-Term Memory neural network (LSTM) uses a gate mechanism to control information flow, including three gates, namely a forget gate FG, an input gate IG, and an output gate OG.

More specifically, iterative computation of the model M in step S230 and step S240 includes the following steps.

In step (1), the input data {D₂}ₜ of each time slice is split into K nine-dimensional vectors Xₜ={X_{[0]}, X_{[1]}, . . . , X_{[K-1]}}ₜ, which are respectively input into K LSTM replica models M={M_{[0]}, M_{[1]}, . . . , M_{[K-1]}} with identical parameters.

In step (2), the current external input X_{t[i]} of the current time slice Tₜ is concatenated with the hidden state Hₜ₋₁ from the previous time slice Tₜ₋₁ to obtain a current neural network input Iₜ of the current time slice T₁, expressed as:

$${I}_{t} = \{ {H}_{t - 1} , {X}_{t [ i ]} \}$$

In step (3), an affine transformation is performed on the current neural network input Iₜ, followed by an activation with a tanh function to obtain the current state update value Uₜ, expressed as:

$${U}_{t} = tanh ( {I}_{t} \times W C + B C )$$

where WC represents a weight in performing the affine transformation on Iₜ, and BC represents a bias for the affine transformation. For the task in this embodiment, WC has a data structure of a 209×200 matrix, and BC has a data structure of a 200-dimensional vector;

In step (4), an element-wise multiplication is performed between the forget gate FG and the cell state Cₜ₋₁ from the previous time slice Tₜ₋₁, and between the input gate IG and the current update value Uₜ, and two multiplication results are summed to obtain the current cell state Cₜ, expressed as:

$${C}_{t} = FG \cdot {C}_{t - 1} + IG \cdot {U}_{t}$$

where FG=sigmoid (Iₜ×WF+BF) IG=sigmoid (Iₜ×WI+BI) WF and WI respectively represent the weights for the forget gate and the input gate in performing the affine transformation on the current input Iₜ of the current time slice Tₜ; BF and BI respectively represent the biases for the forget gate and the input gate in performing the affine transformation. For the task in this embodiment, WF and WI both have a data structure of a 209×200 matrix, and BF and BI both have a data structure of a 200-dimensional vector;

In step (5), the current cell state Cₜ is activated with a tanh function, and then element-wise multiplied with the output gate OG to obtain the current hidden state Hₜ, expressed as:

$${H}_{t} = OG \cdot tanh ( {C}_{t} )$$

where OG=sigmoid (Iₜ×WO+BO); WO represents the weight for the output gate in performing the affine transformation on the current input Iₜ of the current time slice Tₜ; BO represents the bias for the output gate in performing the affine transformation. For the task in this embodiment, WO has a data structure of a 209×200 matrix, and BO has a data structure of a 200-dimensional vector.

In step (6), the current hidden state Hₜ is input into the neural network to participate in a loop calculation for the next time slice Tₜ₊₁, and step (2) to step (5) are repeatedly performed while the current hidden state Hₜ is mapped to a two-dimensional space through an affine transformation, followed by an activation with a softmax function to obtain a current two-dimensional vector Pₜ, and an index value of a larger one of two elements in Pₜ is taken as the current model output Y_{t[i]}, expressed as:

$${P}_{t} = [ {p}_{t}^{0} , {p}_{t}^{1} ] = softmax ( {H}_{t} \times W Y + BY )$$

$${Y}_{t [ 1 ]} = arg max ( {p}_{t}^{0} , {p}_{t}^{1} )$$

where WY represents the weight used in performing the affine transformation on the current hidden state Hₜ, and BY represents the bias used in performing the affine transformation, with a data structure of a 2-dimensional vector. For this embodiment, WY has a data structure of a 200×2 matrix. The current model output Yₜ is a binary classification prediction result for whether the memory cell will fail in the next time slice Tₜ₊₁. Y_{t[i]}=1 indicates a prediction of false failure for the cell in the next time slice, and Y_{t[i]}=0 indicates a prediction of true failure for the cell in the next time slice. For the current two-dimensional vector

$${P}_{t} = [ {p}_{t}^{0} , {p}_{t}^{1} ] ,$$

if Pₜ=[1, 0], i.e., Y_{t[i]}=0, it indicates a true failure of the cell in the next time slice; if Pₜ=[0, 1], i.e., Y_{t[i]}=1, it indicates a false failure of the cell in the next time slice.

In step (7), the two-dimensional vectors

$${P}_{t} = [ {p}_{t}^{0} , {p}_{t}^{1} ]$$

are concatenated along a time dimension to form an output array P of size K×TS×2; the label arrays Cₜ are concatenated along the time dimension to form an output array C of size K×TS×2; the output array P is compared with the output array C to obtain a cross entropy as a loss function, expressed as:

$$L = - \frac{1}{K} {\sum }_{t = 1}^{T S} {\sum }_{i = 1}^{K} {[ {c}_{i}^{1} log {p}_{i}^{1} + {c}_{i}^{0} log {p}_{i}^{0} ]}_{t}$$

where TS represents a training span, the value of which is the number of time slices covered by the training dataset Dₜᵣₐᵢₙ; K is the total number of memory cells in the RRAM chip, the label of a single memory cell has a data structure of [c⁰, c¹], i represents the i^{th} memory cell, and t represents the t^{th} time slice.

The loss is back-propagated and the weights of the K LSTM replica models are updated simultaneously until the loss ceases to decrease, thereby obtaining K trained LSTM replica models, and any one of the replica models may be selected as the final model M_{trained}, where M_{trained}={M_{trained_[0]}, M_{trained_[1]}, . . . , M_{trained_[K-1]}}. Preferably, an Adam optimizer is used for backpropagation and weight updates of the neural network.

Specifically, performing, if the binary classification prediction result indicates a false failure, a secondary determination to obtain a prediction result indicating whether a false failure memory cell actually requires repair in step S140 includes: performing a secondary determination on the prediction result if Y_{t[i]}=1, and if the output result O_{t[i]} for the memory cell in the current set/reset cycle t indicates N+1 set successes and N reset successes, determining that the prediction result indicates that the memory cell does not require repair; otherwise, determining that the prediction result indicates that the memory cell is a false failure memory cell that actually requires repair.

It should be noted that, after obtaining the prediction result for a memory cell following a set/reset cycle, corresponding operations may be performed according to the prediction result.

Examples include: i. if the prediction result indicates that the memory cell will experience a true failure in the next time slice, transferring the data stored in the memory cell to other memory cells; ii. if the prediction result indicates that the memory cell does not require repair, performing no operations; iii. if the prediction result indicates that the memory cell is a false failure memory cell that actually requires repair, performing a repair operation.

Compared with the prior art, the present disclosure may achieve at least the following beneficial effects.

1. The model constructed using the method of the present disclosure achieves a prediction accuracy of 86.75%, which is significantly higher than the 65% accuracy achieved by existing prediction models. Moreover, compared with existing models in which a single prediction period contains an excessively large number of set/reset operations, the model of the present disclosure achieves prediction for a memory cell with fewer set/reset operations. Specifically, the existing models require about 100,000 set/reset operations in a single prediction period, whereas the model of the present disclosure may reduce the number of set/reset operations in a single prediction period to 500, thereby enabling more timely predictions and repairs for memory cells.

2. The model input uses nine-dimensional data, among which three voltage-related parameters SVOLₜ, RVOLₜ, and FVₜ contain key external operation information of the RRAM chip, and six resistance-related parameters SRₜ, RRₜ, SFₜ, RFₜ, SVARₜ, and RVARₜ contain main physical state information of the memory cells of the RRAM chip, which is highly consistent with the physical model of the RRAM resistance switching process, making the constructed time-series model more scientific and effective. Two sets of feature quantities SFₜ/RFₜ and SVARₜ/RVARₜ are used to represent the local fluctuation and global fluctuation of resistance respectively, incorporating the random fluctuations and abrupt changes inherent in RRAM resistance into the model input. Accordingly, the physical state of the RRAM device may be more comprehensively reflected.

3. By initially determining a true failure or a false failure, and performing a secondary determination for a false failure, the lifetime prediction accuracy is improved. This provides an accurate basis for subsequent corresponding operations, such as transferring data stored in memory cells predicted to have true failures and repairing false failure memory cells that are determined to actually require repair, thereby reducing the error rate of memory cells in RRAM chips.

Those skilled in the art will appreciate that all or part of the processes in the methods of the above embodiments may be implemented by instructing relevant hardware through a computer program, and the program may be stored in a computer-readable storage medium. The computer-readable storage medium may include a magnetic disk, an optical disk, a read-only memory, or a random-access memory, etc.

The above description is merely preferred specific embodiments of the present disclosure, and the scope of protection of the present disclosure is not limited thereto. Any changes or substitutions that may be readily conceived by those skilled in the art within the technical scope disclosed in the present disclosure shall fall within the scope of protection of the present disclosure.

What is claimed is:

1. A method for predicting a lifetime of a resistive random access memory (RRAM) chip, comprising:
acquiring measured data of a memory cell in the RRAM chip performing read/write operations in a set/reset cycle under normal operating conditions;
processing the measured data to obtain input data X_{pt[i]}, wherein the input data X_{pt[i]} comprises a forming voltage FV_{pt[i]}, a normalized resistance of set SR_{pt[i]}, a normalized resistance of reset RR_{pt[i]}, a local fluctuation of resistance of set SF_{pt[i]}, a local fluctuation of resistance of reset RF_{pt[i]}, a global fluctuation of resistance of set SVAR_{pt[i]}, a global fluctuation of resistance of reset RVAR_{pt[i]}, an average set voltage SVOL_{pt[i]}, and an average reset voltage RVOL_{pt[i]};
inputting the input data X_{pt[i]} into a corresponding trained failure prediction model to obtain a binary classification prediction result indicating a true failure or a false failure of the memory cell in a next set/reset cycle t+1; and
performing, if the binary classification prediction result indicates a false failure, a secondary determination to obtain a prediction result indicating whether a false failure memory cell actually requires repair.

2. The method according to claim 1, wherein the acquiring measured data comprises:
step (1) of acquiring a forming voltage FVₚ for performing a forming operation on a brand-new RRAM chip; and
step (2) of recording measured data of each memory cell in the formed RRAM chip in each set/reset cycle under normal operating conditions, wherein a set/reset cycle comprises: the memory cell completing a span of operations in the set/reset cycle, and then sequentially completing a first read operation consecutively and repeatedly for a predetermined number n of times, a set operation for one time, and a second read operation consecutively and repeatedly for a predetermined number n of times; a span of operations in the set/reset cycle comprises the memory cell completing set/reset operations for a predetermined number N of times; the measured data Dₚₜ comprises: a set voltage SVOL_RAW_{p[i]}, a reset voltage RVOL_RAW_{p[i]}, a resistance of set SR_RAW_{p[i]} and a resistance of reset RR_RAW_{p[i]} recorded within a span in the set/reset cycle, a resistance of reset sample R_{pr[i]} recorded when performing the first read operation consecutively and repeatedly in the set/reset cycle, a resistance of set sample R_{ps[i]} recorded when performing the second read operation consecutively and repeatedly in the set/reset cycle, a resistance of set R_{pset[i]} and a set voltage V_{pset[i]} recorded between the first read operations and the second read operations, and all output results O_{p[i]} in the set/reset cycle.

3. The method according to claim 1, wherein the processing the measured data to obtain input data X_{pt[i]} comprises:
(1) setting a value of FV_{pt[i]} in a first set/reset cycle to the forming voltage FVₚ of the chip, and setting values in subsequent set/reset cycles to 0, where FV_{pt[i]} represents the forming voltage of the memory cell;
(2) dividing the mean of a raw resistance of set SR_RAW_{pt[i]} by a stable low resistance R_{low} of the RRAM chip to obtain SR_{pt[i]}, where SR_{pt[i]} represents a normalized resistance of set;
(3) dividing the mean of a raw resistance of reset RR_RAW_{pt[i]} by a stable high resistance R_{high} of the RRAM chip to obtain RR_{pt[i]}, where RR_{pt[i]} represents a normalized resistance of reset;
(4) normalizing the resistance of set samples and convolving the normalized resistance of set samples with a one-dimensional edge detection operator [−1, 0, 1] to obtain SF_{pt[i]}, where SF_{pt[i]} represents a local fluctuation of resistance of set of the memory cell;
(5) normalizing the resistance of reset samples and convolving the normalized resistance of reset samples with a one-dimensional edge detection operator [−1, 0, 1] to obtain RF_{pt[i]}, where RF_{pt[i]} represents a local fluctuation of resistance of reset of the memory cell;
(6) normalizing each resistance in the resistance of set samples and calculating a variance to obtain SVAR_{pt[i]}, where SVAR_{pt[i]} represents a global fluctuation of resistance of set of the memory cell;
(7) normalizing each resistance in the resistance of reset samples and calculating a variance to obtain RVAR_{t[i]}, where RVAR_{t[i]} represents a global fluctuation of resistance of reset of the memory cell;
(8) averaging all recorded set voltages within a span in the set/reset cycle to obtain SVOL_{pt[i]}, where SVOL_{pt[i]} represents an average set voltage for the memory cell; and
(9) averaging all recorded reset voltages within a span in the set/reset cycle to obtain RVOL_{pt[i]}, where RVOL_{pt[i]} represents an average reset voltage for the memory cell.

4. The method according to claim 3, wherein the binary classification prediction result indicating a true failure or a false failure is obtained by: inputting the preprocessed data X_{pt[i]} obtained after a set/reset cycle into a trained model M_{trained[i]}, and outputting Y_{t[i]} as the prediction result for the memory cell in the next set/reset cycle t+1, wherein if Y_{t[i]}=1, the prediction result indicates a false failure of the memory cell in the next time slice; and if Y_{t[i]}=0, the prediction result indicates a true failure of the memory cell in the next time slice; and
wherein a prediction result indicating whether a false failure memory cell actually requires repair is obtained by: performing a secondary determination on the prediction result if Y_{t[i]}=1, and if the output result O_{t[i]} for the memory cell in a current set/reset cycle t indicates N+1 set successes and N reset successes, determining that the prediction result indicates that the memory cell does not require repair; otherwise, determining that the prediction result indicates that the memory cell is a false failure memory cell that actually requires repair.

5. The method according to claim 1, wherein the trained failure prediction model is obtained by:
acquiring raw data Dₜ;
preprocessing the raw data to obtain nine-dimensional input data Xₜ={FVₜ, SRₜ, RRₜ, SFₜ, RFₜ, SVARₜ, RVARₜ, SVOLₜ, RVOLₜ};
constructing a dataset D₁ having a data structure of K×9×T according to the nine-dimensional input data, and performing binary classification labeling of true failure or false failure on the dataset D₁ to obtain a model training dataset D₂ consisting of external inputs Xₜ of a model M and corresponding labels Cₜ, where K is a total number of memory cells in the RRAM chip, and T is a number of simulation cycles covered by the raw data; and
training the model M using the model training dataset D₂, wherein the model M comprises K long short-term memory (LSTM) replica models {M_{[0]}, M_{[1]}, . . . , M_{[K-1]}} with identical parameters, and different replica models are configured to independently perform forward inference and error computation for the K memory cells.

6. The method according to claim 5, wherein the model M is constructed based on LSTM, with cell parameters comprising a cell state Cₜ, a hidden state Hₜ, and a state update value Uₜ, and with control gates comprising a forget gate FG, an input gate IG, and an output gate OG, respectively expressed as:
$$FG = sigmoid ( {I}_{t} \times WF + BF ) ,$$
$$I G = sigmoid ( {I}_{t} \times WI + BI ) ,$$
$$OG = sigmoid ( {I}_{t} \times WO + BO ) ,$$
where WF, WI and WO represent weights for the forget gate, the input gate, and the output gate respectively in performing an affine transformation on a current neural network input Iₜ in a current time slice; BF, BI and BO represent biases for the forget gate, the input gate, and the output gate respectively in performing the affine transformation; and
wherein an iterative computation of the model M comprises:
step (1) of splitting input data {D₂}ₜ in each time slice into K nine-dimensional vectors, and inputting the K nine-dimensional vectors respectively into K LSTM replica models with identical parameters;
step (2) of concatenating a current external input X_{t[i]} in a current time slice Tt with a hidden state Hₜ₋₁ from a previous time slice Tₜ₋₁ to obtain a current neural network input Iₜ in the current time slice Tₜ;
step (3) of performing an affine transformation on the current neural network input Iₜ and then performing an activation with a tanh function to obtain a current state update value Uₜ;
step (4) of performing an element-wise multiplication between the forget gate FG and the cell state Cₜ₋₁ from the previous time slice Tₜ₋₁ and between the input gate IG and the current state update value Uₜ, and summing two multiplication results to obtain a current cell state Cₜ;
step (5) of performing a tanh activation on the current cell state Cₜ, and then performing an element-wise multiplication with the output gate OG to obtain a current hidden state Hₜ;
step (6) of inputting the current hidden state Hₜ into the neural network to participate in a loop calculation in the next time slice Tₜ₊₁, repeatedly performing steps (2) to (5) while mapping the current hidden state Hₜ into a two-dimensional space through an affine transformation, performing an activation with a softmax function to obtain a current two-dimensional vector Pₜ, and taking an index value of a larger one of two elements in the current two-dimensional vector Pₜ as a current model output Y_{t[i]};
step (7) of concatenating the two-dimensional vectors Pₜ along a time dimension to form an output array P of size K×TS×2, concatenating the label arrays C₁ along the time dimension to form an output array C of size K×TS×2, and comparing the output array P and the output array C to obtain a cross entropy as a loss function, expressed as:
$$L = - \frac{1}{K} {\sum }_{t = 1}^{TS} {\sum }_{i = 1}^{K} {[ {c}_{i}^{1} log {p}_{i}^{1} + {c}_{i}^{0} log {p}_{i}^{0} ]}_{t}$$
where TS represents a training span, and a value of TS is equal to the number of time slices covered by the training dataset Dₜᵣₐᵢₙ; K is a total number of memory cells in the RRAM chip, a label for a single memory cell has a data structure of [c⁰, c¹], i represents an i^{th} memory cell, and t represents a t^{th} time slice; and
back-propagating a loss and updating weights of the K LSTM replica models simultaneously until the loss ceases to decrease so that K trained LSTM replica models are obtained, and selecting any one of the replica models as a final model M_{trained}, where M_{trained}={M_{trained_[0]}, M_{trained_[1]}, . . . , M_{trained [K-1]}}, and preferably, an Adam optimizer is provided for back-propagation and weight updates of the neural network.

7. The method according to claim 5, wherein the acquiring raw data Dₜ comprises:
step (1) of performing a forming operation on the RRAM chip to switch each memory cell of the chip into a conductive state, and recording a forming voltage FV;
step (2) of verifying a forming result and recording a forming resistance R_{f} and an output result O for each memory cell;
step (3) of performing a set operation on the formed chip, and recording a resistance SR_RAW and a corresponding set voltage SVOL_RAW for each memory cell upon the set operation being successful, or the resistance SR_RAW and the corresponding set voltage SVOL_RAW for each memory cell upon the set operation failing for a predetermined number of times, along with an output result O, wherein the set operation being successful comprises the set operation being successful when being performed once, or the set operation being successful when being performed multiple times not more than the predetermined number of times;
step (4) of performing a reset operation on the formed chip, and recording a resistance RR_RAW and a corresponding reset voltage RVOL_RAW for each memory cell upon the reset operation being successful, or the resistance RR_RAW cell and the corresponding reset voltage RVOL_RAW for each memory upon the reset operation failing for a predetermined number of times, along with an output result O;
step (5) of repeatedly performing the set operation and the reset operation to complete a predetermined number N of cycles in a span, comprising: repeatedly performing step (3) to step (4), defining a completion of a span upon completing the predetermined number of cycles, and proceeding to step (6);
step (6) of repeatedly performing a read operation on a memory array of the chip for a predetermined number n of times to obtain resistance of reset samples Rᵣ for computing a resistance of reset fluctuation;
step (7) of performing a set operation on the chip, and recording a resistance Rₛₑₜ and a current set voltage Vₛₑₜ for each memory cell upon the set operation being successful, or the resistance Rₛₑₜ and the current set voltage Vₛₑₜ for each memory cell upon the set operation failing for a predetermined number of times, along with an output result O;
step (8) of repeatedly performing a read operation for the predetermined number n of times to obtain resistance of set samples Rₛ for computing a resistance of set fluctuation; and
step (9) of defining step (3) to step (8) as a simulation cycle, and performing T simulation cycles to obtain the raw data Dₜ={FV, SVOL_RAW, RVOL_RAW, SR_RAW, RR_RAW, R_{f}, Rₛ, Rₛₑₜ, Vₛₑₜ . . . }ₜ.

8. The method according to claim 5, wherein the external input Xₜ comprises:
(1) FVₜ represents a forming voltage, a value of FVₜ in a first time slice is set to the FV in the raw data, and values for subsequent time slices are set to 0;
(2) SRₜ represents a normalized resistance of set and is obtained by dividing the mean of a raw resistance of set SR_RAW by a stable low resistance R_{low} of the RRAM chip, R_{low} is a low resistance of a memory cell during a normal operation of the RRAM chip and also a low resistance in the most stable state;
(3) RRₜ represents a normalized rest resistance and is obtained by dividing the mean of a raw resistance of reset RR_RAW by a stable high resistance R_{high} of the RRAM chip, R_{high} is a high resistance of a memory cell during a normal operation of the RRAM chip and also a high resistance in the most stable state;
(4) SFₜ represents a local fluctuation of the resistance of set of the memory cell and is obtained by normalizing the resistance of set samples and convolving the normalized resistance of set samples with a one-dimensional edge detection operator [−1, 0, 1];
(5) RFₜ represents a local fluctuation of the resistance of reset of the memory cell and is obtained by normalizing the resistance of reset samples and convolving the normalized resistance of reset samples with the one-dimensional edge detection operator [−1, 0, 1];
(6) SVARₜ represents a global fluctuation of the resistance of set of the memory cell and is obtained by normalizing each resistance in the resistance of set samples and calculating a variance;
(7) RVARₜ represents a global fluctuation of the resistance of reset of the memory cell and is obtained by normalizing each resistance in the resistance of reset samples and calculating a variance;
(8) SVOLₜ represents an average set voltage of the memory cell and is obtained by averaging all recorded set voltages within a span in the simulation cycle; and
(9) RVOLₜ represents an average reset voltage of the memory cell and is obtained by averaging all recorded reset voltages within a span in the simulation cycle.

9. The method according to claim 5, wherein the performing binary classification labeling of true failure or false failure comprises:
step (1) of determining a state result S_{t[i]} of the memory cell in a (t+1)^{th} simulation cycle according to an output result O_{t+1[i]} within each span in the (t+1)^{th} simulation cycle, wherein:
a) if O_{t+1[i]} does not contain set success or reset success, the state result S_{t+1[i]}=0, indicating that the memory cell undergoes a true failure in the (t+1)^{th} simulation cycle; or
b) in other cases except a), the state result S_{t+1[i]}=1, indicating that the memory cell undergoes a false failure in the (t+1)^{th} simulation cycle;
step (2) of assigning a corresponding label
$${c}_{t [ i ]} = {[ {c}_{i}^{0} , {c}_{i}^{1} ]}_{t}$$
to X_{t[i]} according to the state result S_{t+1[i]}, where superscripts 0 and 1 represent indices of a two-dimensional vector, wherein:
i. if the state result S_{t+1[i]}=0, a corresponding label c_{t[i]}=[1, 0]ₜ is assigned to X_{t[i]}; and
ii. if the state result S_{t+1[i]}=1, a corresponding label c_{t[i]}=[0, 1]ₜ is assigned to X_{t[i]}; and
step (3) of constructing T matrices of size K×2 on a per-time-slice basis as labels Cₜ corresponding to external inputs Xₜ of the model M, where Cₜ={C_{[0]}, C_{[1]}, . . . , C_{[K-1]}}ₜ; combining each Xₜ and the corresponding label Cₜ to form model training data D_{2_t}, and constructing T model training data D_{2_t} on a per-time-slice basis as the model training dataset D₂, where D₂={D_{2_0}, D_{2_1}, . . . , D_{2_T-1}}.

10. The method according to claim 5, wherein the training a model M using a model training dataset D₂ comprises:
dividing the model training dataset D₂ by time slices into a training dataset Dₜᵣₐᵢₙ and a test dataset Dₜₑₛₜ, wherein data of first TS time slices in the model training dataset D₂ is allocated to the training dataset Dₜᵣₐᵢₙ={D_{2_0}, D_{2_1}, . . . , D_{2_TS-1}}, and data of the remaining T-TS time slices is allocated to the test dataset Dₜₑₛₜ={D_{2_TS-1}, D_{2_TS}, . . . , D_{2_T-1}};
initializing the model M to set initial values of a cell state and a hidden state of the LSTM to 0; and constructing the model M as K LSTM replica models {M_{[0]}, M_{[1]}, . . . , M_{[K-1]}} with identical parameters; and
splitting input data {D₂}ₜ of each time slice in the training dataset Dₜᵣₐᵢₙ into K nine-dimensional vectors Xₜ={X_{[0]}, X_{[1]}, . . . , X_{[K-1]}} it, sequentially inputting the split data in time-slice order into the K LSTM replica models M={M_{[0]}, M_{[1]}, . . . , M_{[K-1]}} with identical parameters for model training to obtain K trained replica models, selecting any one of the K trained replica models as a final model M_{trained}, and testing the final model M_{trained} using the test dataset Dₜₑₛₜ.
